(19) United States
(12) Patent Application Publication
(10) Pub. No.: US 2004/0215467 A1
(43) Pub. Date: Oct. 28, 2004

(54) Method and system for electronic document handling, such as for requests for quotations under an electronic auction

(76) Inventors: Kathryn D. Coffman, Greer, SC (US); Paula J. Duell, Austell, GA (US); Vincio B. Tiburcio, Kennesaw, GA (US)

Correspondence Address: PERKINS COIE LLP, PATENT-SEA, P.O. BOX 1247, SEATTLE, WA, 98111-1247, US

(21) Appl. No.: 09/754,028

(22) Filed: Jan. 3, 2001

(51) Int. Cl. G06F 17/60

(52) U.S. Cl. 705/1

(57) ABSTRACT

A system for handling electronic documents, such as requests for quotations used in procurement under an electronic auction, includes several features. Once the need to procure a new item (or service) is identified, an electronic request for quotations (“RFQ”) is generated. Under one embodiment, one or more electronic forms, such as Web page screens, prompt an RFQ author for data entry. Previously prepared RFQs may be readily retrieved and amended. The system requires certain fields to be completed so that RFQ generation is uniform across an organization and RFQs are unambiguous for suppliers. The electronic RFQ is provided to suppliers well before an auction.

### TECHNICAL FIELD

The disclosure relates generally to document handling, and more particularly, to electronic requests for quotations.

### BACKGROUND AND SUMMARY

Many businesses, particularly those in the manufacturing industries, wish to obtain raw materials and parts at the lowest possible price while ensuring quality, timely delivery and other factors important to the business. The requisitioning process for procuring materials or goods has often been a labor-intensive, inefficient and nonstandardized process. In general, a buyer must first decide what he or she will buy; second, identify sources for the items to be purchased; and third, identify what must be performed to qualify a source or item supplied by the sources.

FIGS. 1A and 1B show an example of a typical requisitioning process 100. Beginning in block 102, a buyer identifies something that needs to be purchased and when it must be delivered. In block 104, the buyer determines whether a purchasing contract is in place for the item. If so, then in block 106, the existing purchasing contract is employed. If not, then in block 108, the buyer identifies one or more suppliers capable of supplying the item. In block 110, if the buyer is not approved, then in block 112, the buyer must be preapproved, such as by executing a secrecy agreement.

In addition to identifying suppliers, the buyer must prepare an RFQ. An RFQ, or “Request For Quotations,” contains information suppliers need to prepare a bid or quotation. The RFQ likely also includes information or details regarding aspects of the item to be purchased that are important or critical to the buyer. (While RFQs are described herein, the following description applies equally to requests for proposals (“RFPs”) and related documents generated by one party and distributed to multiple parties to obtain a preferred or best response (in the eyes of the preparer) under a generally competitive process.) Typically, the RFQ is not reviewed for completeness, and is often used only for domestic suppliers. Thus, certain additional information is not required, such as export control licenses and the like. The identified suppliers (previously approved, or approved under block 112) receive the RFQ, such as by mail or email, under block 116. In block 118, the business receives technical proposals and proposed deviations or exceptions to the RFQ from one or more suppliers. The buyer or other evaluator can determine whether the product or item proposed by a supplier is acceptable for the buyer's intended application. If not, the supplier may not be permitted to participate.

In block 120, bids begin to trickle in from the suppliers and all bids are 0 considered received by some cutoff point (under block 122). In block 124, the buyer negotiates with one or more suppliers based on the received bids, and in block 126 determines a supplier from whom to purchase the desired item. In block 128, the buyer provides oral or written feedback to the suppliers identifying, for example, the supplier selected and possible reasons for the selection.

Under block 130, if the item purchased requires qualification, then in block 132, a qualification plan is defined by the buyer, a quality assurance individual, or some other person. In block 134, the buyer or other individual requests samples from the supplier in order to execute the qualification plan. In block 136, the qualification plan is executed and the purchased items are tested. If the items do not qualify under block 138, then in block 140, it is determined whether time exists to retest the items. If so, the process loops back to block 136, and if not, the buyer may renegotiate with the supplier or one or more other qualified suppliers, under block 142. If the samples pass qualification testing, and the vendor does not have a vendor number, under block 144, the buyer or other individual obtains a supplier or vendor number, in block 146. Following blocks 130, 142, 144 or 146, “Material Requisition Planning” (“MRP”) or purchasing system data is updated, such as to include a vendor number, under block 148, and in block 150, the MRP system automatically generates one or more purchase orders to purchase the required items.

An MRP system is a system by which purchasing contracts are planned based on the need date of the purchased item. For “direct material” (i.e., purchased material that is incorporated directly into a product to be sold), the MRP system employs or calculates a quantity of an item required based on sales that incorporate that purchased item. For “indirect material” (i.e., purchased material that is consumed rather than converted into a sold product), the MRP system employs or calculates the appropriate reorder time/amount based on stock-on-hand and consumption rate. The MRP system contains complete supplier and product information, such as the most recent quotes, preferred vendor identification and the like. MRP systems are well-known in the art, and employ automated software tools to perform such processes, automatically generating purchase orders as required to purchase items the system forecasts will be needed by the anticipated delivery date of such items.

There are many bottlenecks in the process described above. Examples of such bottlenecks are indicated by ovals within FIGS. 1A and 1B. One significant bottleneck involves RFQs. Preparing an RFQ was a lengthy, manual process that often required lo considerable manual manipulation of documents and spreadsheets to fit many nonstandard RFQ transactions into a standard electronic template. Each RFQ typically differed between buyers, and even between items purchased by a single buyer due, for example, to the differences between items and differing end uses. This caused at least three problems.

First, due to time required to generate the RFQ, the RFQ process occurred later than required by the operational needs, and suppliers were given insufficient time to prepare their bids between the issuance of the RFQ and the execution of the REQ process. (The RFQ process may be performed in a variety of ways, such as via reverse auction, as described herein.) Second, due to the diversity of business needs, no standardized RFQ format existed within organizations, resulting in RFQs being submitted with data that was either missing or difficult to reformat. This caused suppliers to make assumptions which invalidated their responses or simply delayed the execution of the RFQ process. Third, the review cycle for the RFQ resulted in multiple versions of the RFQ (and its associated attachments) being in circulation concurrently, so that revision control became difficult and errors were inadvertently provided to suppliers. Furthermore, distributing paper RFQs could take more than a week to reach some global suppliers, while domestic recipients received them within a couple of days. Email proved ineffective because many attachments were often too large to be handled by many mail servers. Thus, preparers of RFQ document packages would devote large amounts of time assembling and distributing data, verifying supplier receipt of the data, clarifying issues with multiple recipients of the data and reviewing counter proposals. Many other problems with RFQs resulted in delays in the requisitioning process.

Another problem with prior requisitioning systems was that they typically were inefficient at managing high-volume activities, incapable of handling high-speed negotiations, incapable of purchasing foreign-manufactured goods, unable to leverage across business units, ineffective with communications and transactions, and fraught with time-zone problems and/or other problems. For example, an RFQ may have been provided to suppliers without providing the suppliers with corresponding adequate preparation time. In general, bottlenecks occur in generating and distributing the RFQ (e.g., gathering and including drawings and pictures, identifying leveraging opportunities), obtaining vendor numbers, updating MRP or purchasing systems, etc.

As noted above, prior art attempts to automate the requisitioning process included using email. However, email often has limitations in sending large electronic documents. Furthermore, many steps in the process described above are manual. The inventors have found that using a public computer network, such as the Internet, may be employed to improve efficiency.

The Internet is increasingly being used to conduct “electronic commerce.” The Internet comprises a vast number of computers and computer networks interconnected through communications channels. Electronic commerce generally refers to commercial transactions that are at least partially conducted by using the computer systems of the parties to the transactions. For example, a purchaser can use a personal computer to connect via the Internet to a vendor's computer. The purchaser can then interact with the vendor's computer to conduct the transaction.

The World Wide Web portion of the Internet is especially conducive to conducting electronic commerce. Many Web servers have been developed through which vendors can sell items. Generally, an “item” is any product, service, or exchangeable entity of any type. A server computer system may provide an electronic version of a catalog that lists available items. A user, who is a potential purchaser, may browse through the catalog using a browser and select various items that are to be purchased. When the user has completed selecting the items to be purchased, the server computer system prompts the user for information to complete the ordering of the items. This purchaser-specific order information may include the purchaser's name, the purchaser's credit card number and a shipping address for the order. Typically, the server computer system then typically confirms the order by sending a confirming Web page to the client computer system and schedules shipment of the items.

The World Wide Web is also being used to conduct other types of commercial transactions. For example, some server computer systems have been developed to support conducting auctions electronically. To conduct an auction electronically, the seller of an item provides a definition of the auction to a server computer system via Web pages. The definition includes a description of the item, an auction time period and optionally, a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

A reverse auction may be preferred for procurement. A “reverse auction” is one in which the purchaser states requirements. Then, suppliers who can meet the stated requirements compete for the business by offering the lowest price, quickest delivery or whatever other conditions are sought by the purchaser. It is “reverse” because the usual competitive factor is price, and unlike a typical auction (“forward auction”), price goes down as the auction progresses.

Described in detail below is a method and system to improve electronic document production and handling, such as for requests for quotations, requests for proposals and the like.

### BRIEF DESCRIPTION OF THE DRAWINGS

FIGS. 1A and 1B together form a flow diagram illustrating an example of a prior art procurement process which includes manual RFQ generation.

FIG. 2 shows a home page computer screen with a hypertext link for accessing a depicted Create New Auction Web page screen.

FIG. 3 is an enlarged view of the Create New Auction screen of FIG. 2.

FIGS. 4 and 5 are alternative Web page screens to the Create New Auction screen of FIG. 3.

FIG. 6 is an example of a Web page screen acknowledging the creation of a new auction and providing a link to access screens for creating an electronic RFQ.

FIG. 7 is an example of a Create RFQ Web page screen.

FIGS. 8 and 9 are examples of alternative Web page screens to the Create RFQ screen of FIG. 7.

FIG. 10 is a computer screen showing an example of an auction RFQ attachment viewer.

FIG. 11 is an example of a Web page screen for providing auction-specific information.

FIG. 12 is an example of a Web page screen acknowledging creation of an RFQ.

FIG. 13 is a block diagram illustrating a suitable hardware environment for implementing aspects of the invention.

FIG. 14 is an example of a Web page screen displaying additional RFQ generation options.

FIG. 15 is an example of a Web page screen providing electronic auction options.

FIG. 16 is a flow diagram illustrating an example of an RFQ and auction generation method.

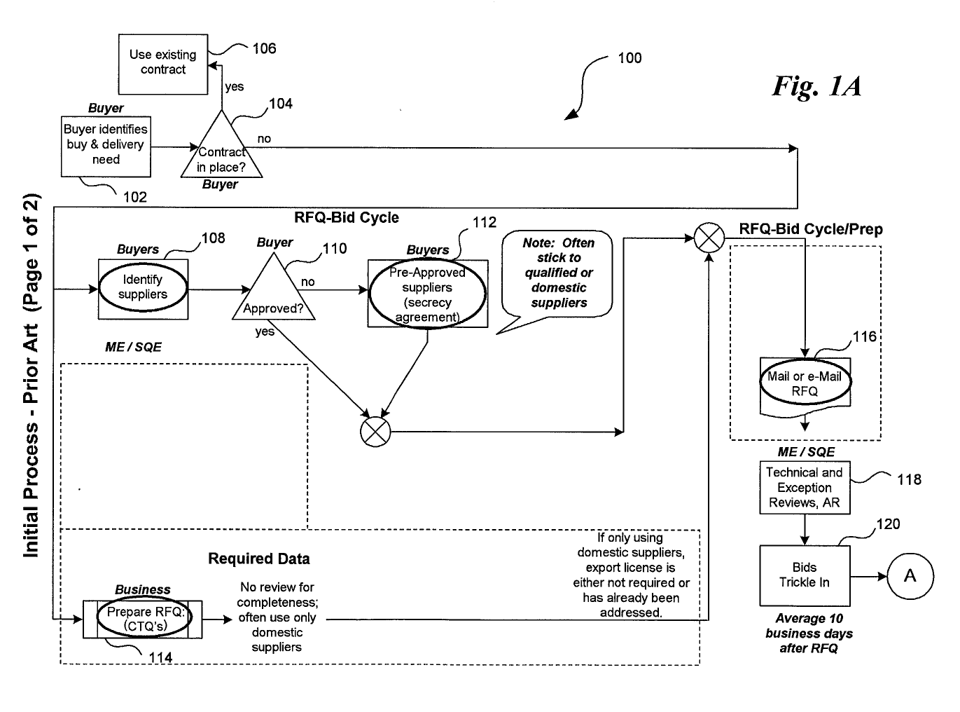

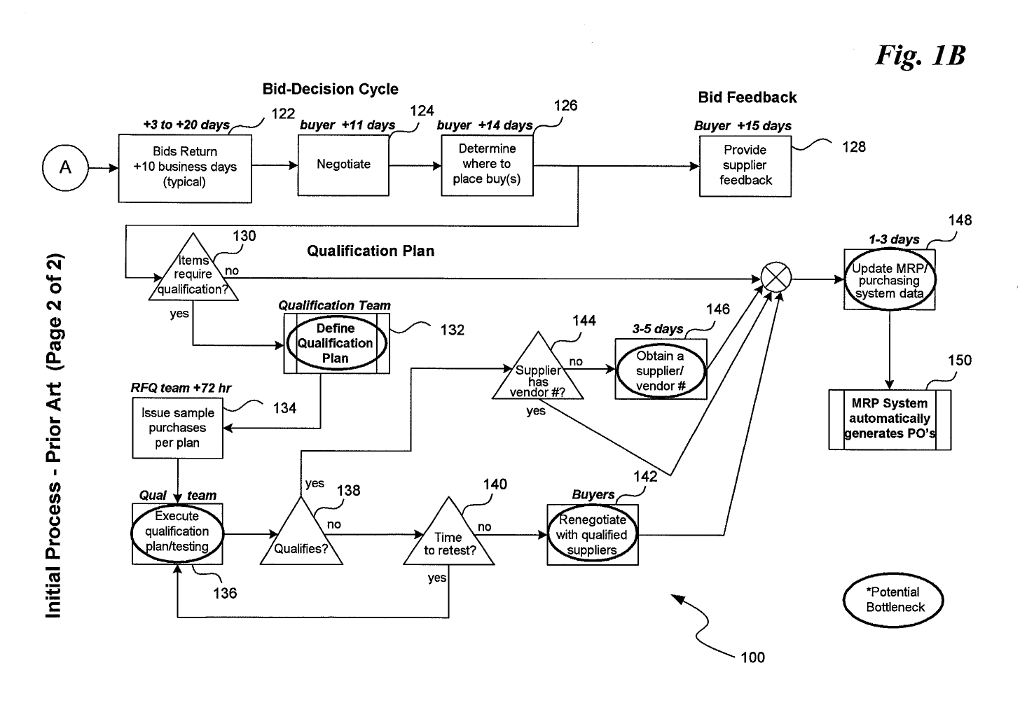

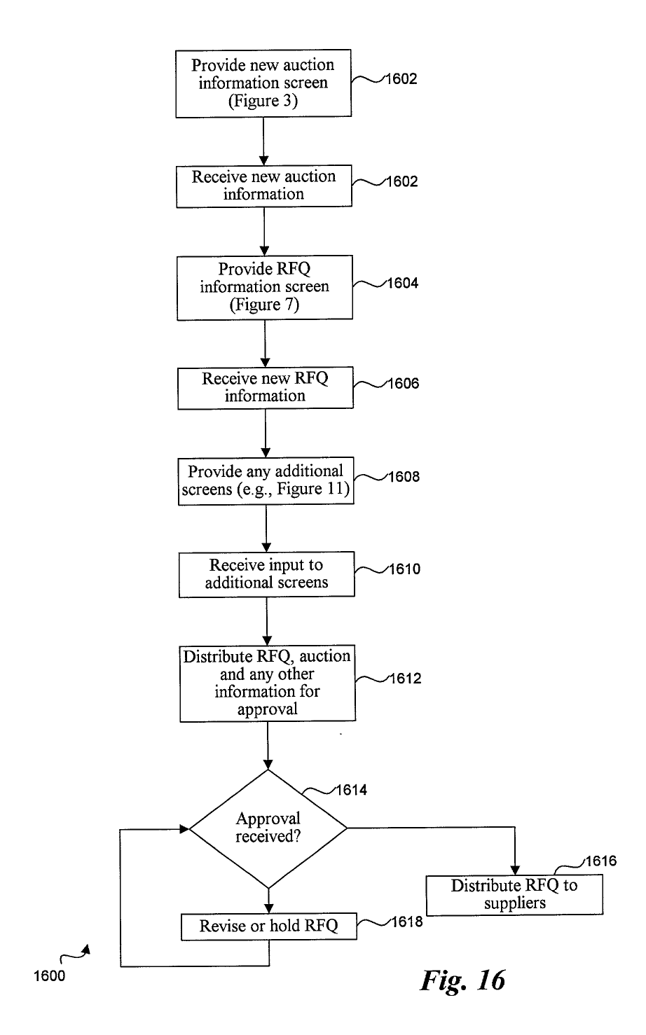

In the drawings, identical reference numbers identify identical or substantially similar elements or acts. To easily identify the discussion of any particular element or act, the most significant digit or digits in a reference number refer to the Figure number in which that element is first introduced (e.g., block 1604 is first introduced and discussed with respect to FIG. 16).

The headings provided herein are for convenience only and do not affect the scope or meaning of the claimed invention.

### DETAILED DESCRIPTION

A process for preparing, modifying and distributing electronic documents, such as for use in electronic auctions, is described in detail below. In the following description, numerous specific details are provided, such as specific data fields and forms, ordering of processes, necessary input fields and the like, to provide a thorough understanding of, and enabling description for, embodiments of the invention. One skilled in the relevant art, however, will recognize that the invention can be practiced without one or more of the specific details, or with other fields, forms or processes, etc. In other instances, well-known structures or operations are not shown or described in detail to avoid obscuring aspects of the invention.

In general, the process and system described in detail herein provide a computer network-based tool that enables buyers to generate electronic requests for quotations, requests for proposals or similar documents (generally referred to herein as “RFQs”). For example, the system may be used with the Internet or another computer network to enable buyers and commodity leaders to electronically distribute RFQs for electronic auctions (such as reverse auctions) conducted by procurement or sourcing departments within a business organization. A commodity leader (described below) may identify common items that must be purchased across business groups or by various buyers within the business organization.

The system reduces RFQ preparation time by employing a menu-based data entry method while still providing flexibility for user-defined data fields and capability to interface with common spreadsheets. The system standardizes the RFQ format across a business, such as a multi-national and multi-functional corporation, to eliminate data omission caused by a nonuniform approach. The RFQ process may thus become a virtually paperless process, both in the generation and review stage and in the distribution phase. If electronic auctions are employed, the system described herein greatly improves RFQ cycle time generation for the auction, such as by eliminating reformatting and reentry of data. Each generated RFQ may be stored electronically at a central location for online retrieval to permit later buyers to reuse or revise existing RFQs, particularly when a similar RFQ has previously been prepared. Assuming suppliers have access to the Internet, the RFQ may instantaneously be distributed electronically to multiple suppliers, thereby saving both time and postage. Furthermore, aspects of the system enable rapid dissemination of smaller documents via email (such as responses to questions and the like), and rapid notification to suppliers that larger documents are available to download from a central Web server. Moreover, the system may automatically record key business cycle metrics, thereby enabling process improvement activities within a business organization without added overhead of manual data collection. The system requires a buyer to enter all “mandatory” data fields so that suppliers do not have to make detrimental assumptions or ask clarifying questions which might delay an auction.

As explained in more detail below, one embodiment of the system contains Web pages or templates that include standard terms and conditions, auction timing, currency and shipping requirements, whether the bid is sealed or employs an interactive auction format, etc. Thus, several fields within the Web page form require mandatory entries. The database employs a user interface that permits quick data entry while still collecting sufficient information for useful sorting of data within the RFQ. Buyers may add additional fields to the RFQ form, add titles to these fields, and arrange the fields to be printed on the RFQ in such a way as to avoid truncating any data while being visually linked to the item or items that are the subject of the RFQ. For example, if there are ten drills to be purchased which can be differentiated by length, material composition, and diameter, then the auction item list permits the originator of the RFQ to add columns titled “length,” “material,” and “diameter.” A single item to be purchased by an auction might have entries into those fields of “5 inches,” “solid carbide,” and “⅜ inch.” The commercial or supplier presented auction site on the Internet might have only a single “description” field, into which this better defined information must be truncated: “Drill, length 5 inches, material solid carbide, diameter=⅜ inches.” The system may generate customized “general requirements and notes” that pertain to the entire auction itself. This information is typically entered into a “comments to suppliers” field in the RFQ template. If there is ambiguity regarding a specific data entry field, the system may provide either an example or a “help” or “about” key or button to describe in more detail the information requested and in which format data should be entered. The Web page forms enable automatic generation of RFQ text through intuitive menu selections and “fill-in-the-blanks” features.

The system provides standardized minimum input fields to force buyers or other users to provide minimum required data to launch a successful electronic auction. The system enables entry of user-defined RFQ data fields (and associated data) relevant to unique needs of an item being submitted for a bid, a business unit's needs, etc. The system queries the buyer regarding how much time the RFQ needs to be in a supplier's hands before the auction start date (with some default value, such as two weeks, with comments required for less than a two week period). The system enables photographs, drawings or other electronically transferable documents to be attached to the RFQ by way of a centralized document library posted on a Web server. The system may record the date an RFQ is initiated, with author information, to measure RFQ generation and auction processes. The system may permit questions and answers to be posted at a Web site before a specific auction, which all suppliers invited to participate in the auction may access. The system may permit the buyer or auction owner to establish a technical reviewer or review team and specify a pre-auction date for all technical proposals and exceptions inquiries to be received from suppliers. Furthermore, the system permits the auction owner to prepare a pre-auction email to all suppliers without disclosing supplier identities to competitors; this e-mail contains general information for the suppliers and a supplier-unique user identification and password to access the auction site (that will permit document download at a user-defined time before the auction).

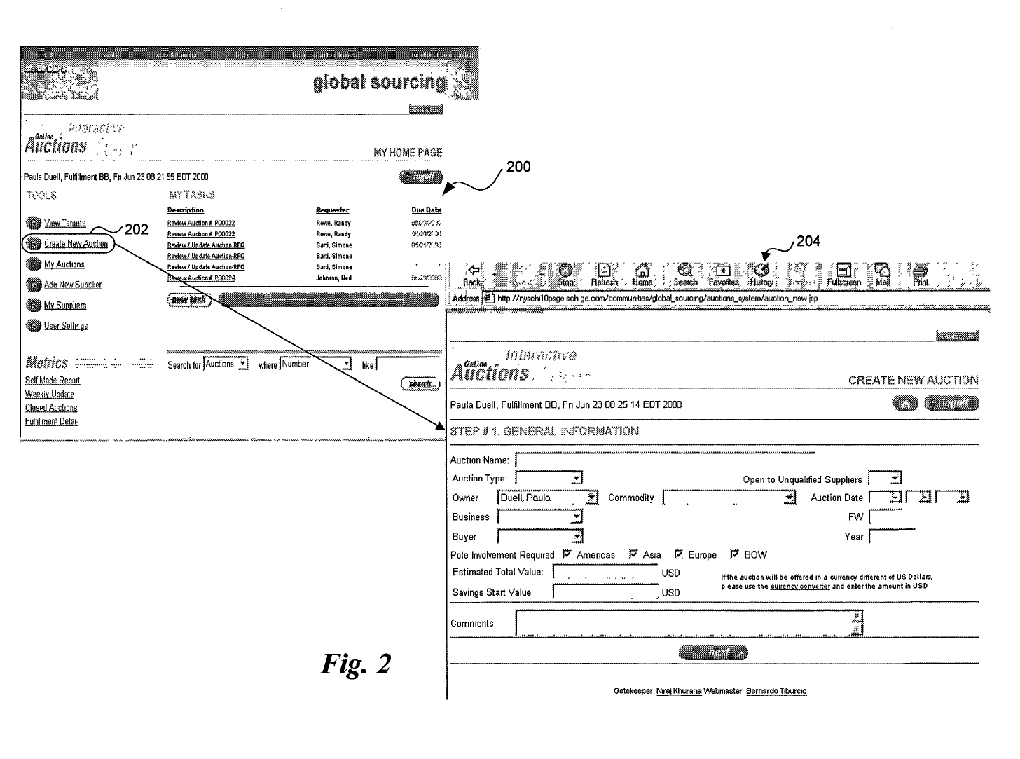

Referring to FIGS. 2 through 12, representative computer displays or Web pages will now be described with respect to generating RFQs, such as for use with an electronic auction. The Web pages may be implemented in XML (Extensible Markup Language) or HTML (HyperText Markup Language) scripts that provide information to a user. The Web pages provide facilities to receive input data, in the form of fields of a form to be filled in, selections from pull-down menus or entries allowing one or more choices, buttons, sliders, or other known user interface tools for receiving user input in a Web page. Of course, while one or more ways of displaying information to users in pages are shown and described herein, those skilled in the relevant art will recognize that various other alternatives may be employed. The terms “screen,” “Web page” and “page” are generally used interchangeably herein. While XML and HTML are described, various other methods of creating displayable data may be employed, such as the Wireless Access Protocol (“WAP”).

The Web pages are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locater identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), matrix or bit-mapped formats. All aspects of the invention are described herein using a networked environment, some or all features may be implemented within a single-computer environment.

Referring to FIG. 2, a suitable, customized home page 200 is shown for a user of the system (e.g., “Paula Duell”). The home page 200 includes a Create New Auction link 202 which, if selected by a user, causes retrieval and display of an appropriate Create New Auction screen, such as the Web page 204 shown in FIG. 2.

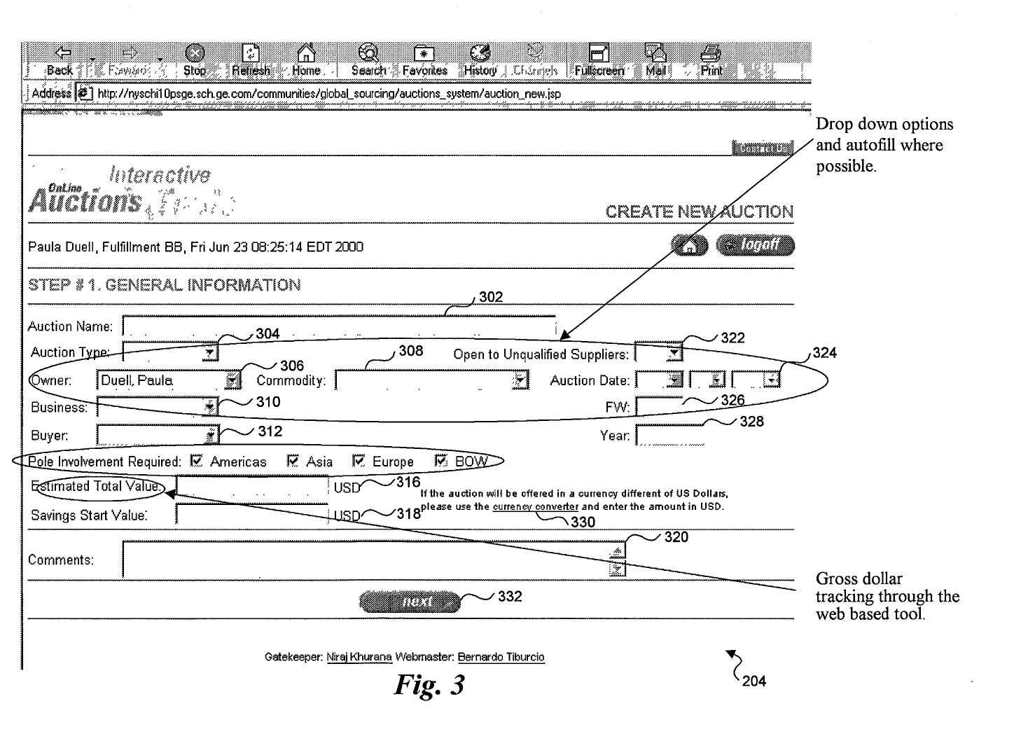

Referring to FIG. 3, the Create New Auction page 204 is shown in greater detail. As shown in FIG. 3, the Create New Auction page includes an Auction Name field 302 for the user to assign an alpha-numeric name to be used for the auction, such as the name of the commodity to be purchased. An Auction Type field 304 includes a pull-down menu of auction types, such as “Forward,” “Reverse,” and “Reverse-Sealed.” Under one embodiment, the default is “Reverse.” In general, the default values described herein are with respect to the depicted embodiment; those skilled in the relevant art will readily recognize that other default values may be selected. A “Sealed” auction, as generally used herein, refers to an auction where bids or other information provided by suppliers is not shared or made available to other suppliers.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not merely by such definitions.

Under an alternative embodiment, an auction type may be selected as “Reverse Sealed,” which may then be automatically reverted to a standard “Reverse” auction after some predetermined time. Thus, under this alternative embodiment, the auction owner may provide a time period after which the Reverse Sealed auction converts to a standard Reverse auction, or the owner may employ a standard default time period (e.g., one day). While not shown, the auction type field may include an “Info” button to permit the auction owner or other user to click on the button and obtain information regarding the various auction types. In general, while not generally shown or described herein, some or all of the fields in the various screens may include an “Info” button or icon that an author or user can click on to obtain a full definition of what is required in the field or what the definition of the field title is.

In an Owner field 306, the system may automatically enter the user or “author” currently filling in the Web page (in this example, Paula Duell). In one embodiment, this field can be altered only by the current author, which thereafter automatically transfers full editing capability to the newly selected author. A Commodity field 308 provides a pull-down menu of commodities purchased by the business organization. Examples of such commodities include: machinings, fabrications, mechanical and fluid systems, castings, forgings, piping, balance of plant, electrical, combustion, Maintenance Repair and Operations (“MRO”) items, chemicals, facilities, utilities, environmental health and safety (“EHS”), logistics, capital expenditures, tooling/fixtures, engineering services, software, leased labor services, and office technology (all with respect to, for example, a power systems manufacturer). By selecting one of the commodities from the pull-down menu, additional fields within this and other Web pages are set as defaults, such as a default Global Commodity Leader (“GCL”) and commodity black belt. In other words, the Commodity field is linked with other fields within the Web page forms. Other fields are similarly linked, as described herein.

A GCL is a single commodity expert across an entire business (across distinct profit and loss centers). The GCL strategize where and how to purchase, how to leverage volume, and how to split purchases to best utilize or manage an available supply base. The GCL works for a sourcing functional manager rather than directly for production within the organization. As indicated by their title, GCLs are expected to be familiar with the entire world's supply capability and price structure for their particular commodities.

A commodity “black belt” (“BB”), as generally used herein, refers to individuals within the business organization who characterize and optimize key processes that exert undue influence on the business landscape. They identify and execute projects that will reduce errors and defects in industrial and commercial processes, and in products and services (e.g., reduce labor, material, cycle time and inventory). Further information regarding black belts may be found in M. Harry and R. Schroeder, Six Sigma, Breakthrough Management Strategy Revolutioning the World's Top Corporations (Currency Press, 2000).

A Business field 310 includes a pull-down menu of all business units associated with the business organization, such as “Energy Products-Gas,” “Energy Products-Steam,” etc. As a default, the system may populate the Business field with the author's associated business unit (from the owner field 306). Not only business units but, also specific sites for such units may be provided for the business field to permit a lowest possible level for tracking and statistical metric generation.

A Buyer field 312 provides a pull-down menu listing in alphabetical order all global buyers within the organization, such as in the format of “last name, first name.” The Buyer field may be linked to the Business field 310 (and other fields, such as an e-business leader field, described below). A “buyer,” as generally used herein, refers to an individual or group chiefly responsible for maintaining work flow by contracting for and ensuring delivery of purchased items or services. Buyers are typically very familiar with a finite scope of purchased items, established suppliers of those items, and the logistics and timing issues involved with procuring those items. In practice, buyers have traditionally handled negotiations for purchases; under alternative embodiments, GCLs perform some negotiations to leverage volume, share best practices, and use preferred suppliers. The buyer may often be the author of the RFQ and auction, as described herein.

A Pole Involvement Required field 314 indicates whether suppliers in various geographic poles (and corresponding pole personnel) are to be involved in the auction. As shown, examples of such geographic poles include “Americas” or “Latin America”, “Asia,” “Europe,” and “BOW” (balance of world), where a default selects all poles. A “pole,” as generally used herein, refers to a specific region of the world targeted as having a low-cost, high quality or other required supply base for items consumed by a purchasing organization. A pole may be a preferred source for particular items due to labor costs within such region, such as the Asian pole for textiles and hand tools. Within each identified pole sourcing engineers are located. “Sourcing engineers” are personnel who identify and develop good suppliers within that region and may be the pole personnel themselves. “Pole personnel” are generally local nationals working directly with suppliers and national commerce organizations to attract business into the geographic region; thus, they work with the GCL, for example, to encourage bids under an electronic auction to suppliers within that pole.

A Estimated Total Value field 316 allows the author to input an estimated total value for the commodity being purchased based on current pricing, while a Savings Start Value field 318 allows the author to input the best probable price before conducting the auction; this will later be compared with the best acceptable bid resulting from the auction in order to determine an auction savings benefit and/or other metrics. A Comments field 320 allows the author to input comments with respect to the auction. An Open To Unqualified Suppliers field 322 includes a yes/no pull-down menu to indicate whether the auction will be open to unqualified suppliers. (“Qualified” implies that the supplier has successfully supplied acceptable product of the type to be auctioned to the purchasing business unit in the past; qualification often requires testing, either destructive or non-destructive in nature, and documentation of the test results and assessments by a qualification review team.) An Auction Date field 324 allows the author to input the month, day and year for the date (or proposed date) of the auction, and may include a pull-down menu for rapidly inputting the date. A fiscal week (FW) field 326 and Year field 328 identify the fiscal week and year for the auction, and may be automatically completed based on the auction date previously entered.

A currency converter link 330 provides a link to a currency calculator applet (not shown) that permits the author to convert foreign currencies to U.S. dollars, such as in a separately opened window or frame (not shown); this is of use whenever currency exchange conditions favor performing an auction in foreign currency or if a pre-quote was obtained in foreign currency. A next button 332 allows the author to proceed to the next step, i.e., completing an RFQ Web page form.

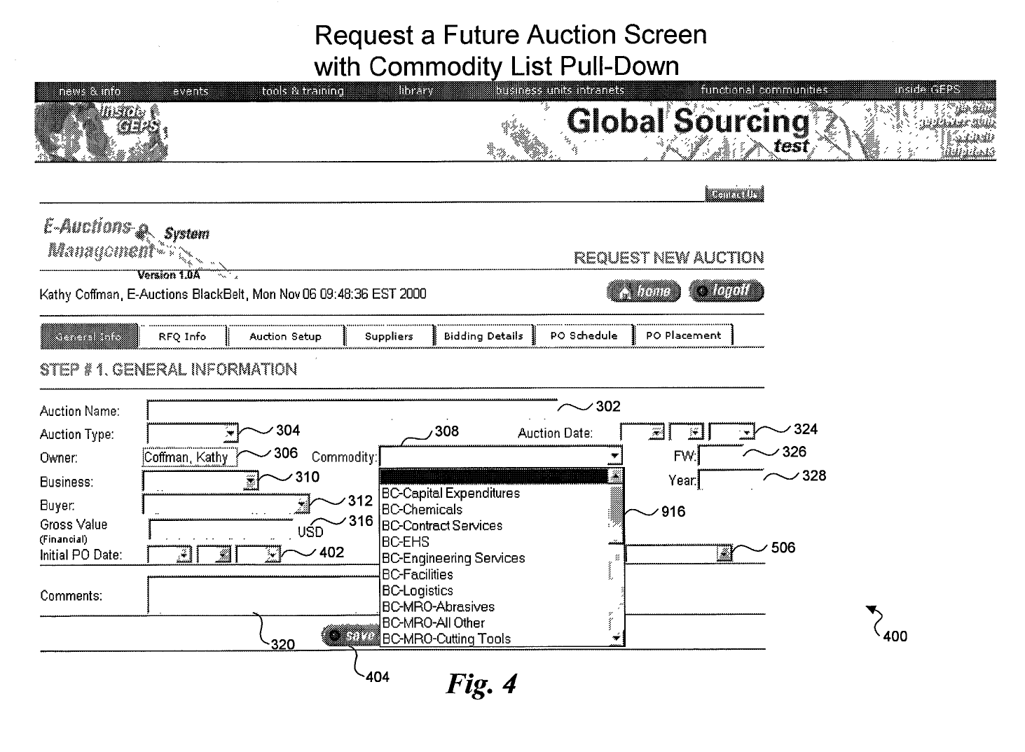

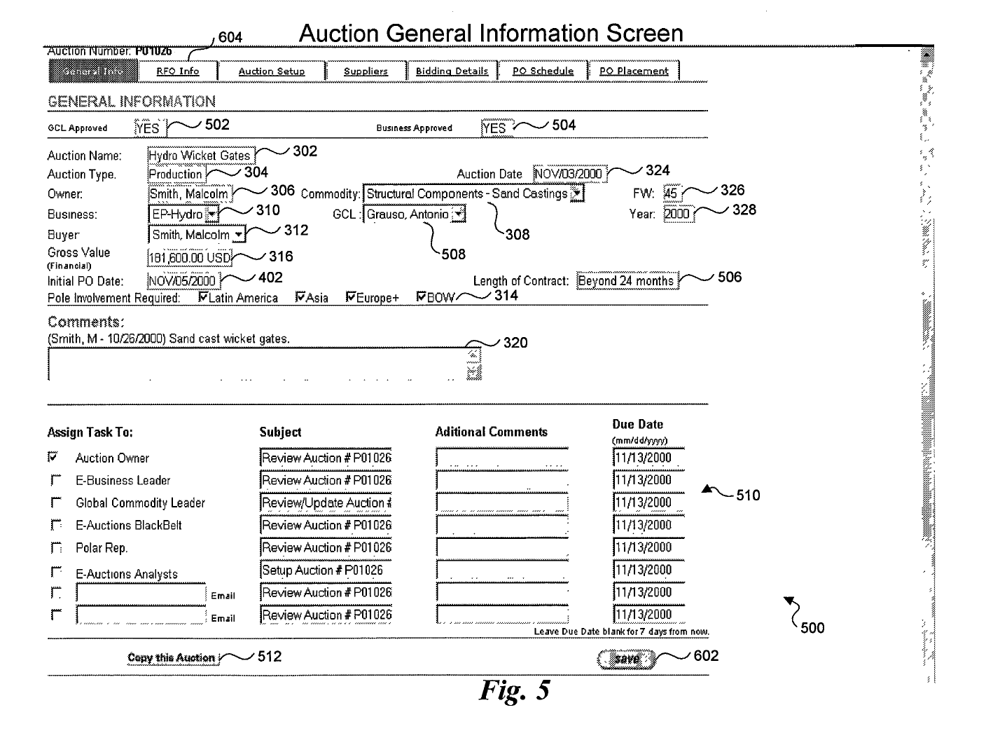

Referring to FIGS. 4 and 5, alternative Web pages to the Create New Auction page 204 of FIG. 3 will now be described. In general, alternatives and alternative embodiments described herein are substantially similar to previously described embodiments, and common elements, acts or steps are identified by the same reference numbers. Only significant differences in construction or operation are described in detail. In this alternative embodiment, the author initially requests that a new auction occur at some point in the future, to reserve time for appropriate support personnel, and to permit the GCL and others to identify any cross-business leveraging. Thus, the author initially completes a Request New Auction screen 400 which is substantially similar to the screen 204.

In one embodiment, the GCL may consider cross-business initiatives. “Cross-business,” as generally used herein, refers to sharing information for grouping purchased volumes of items to facilitate better negotiation with suppliers. Cross-business refers to collaboration between business units with each having different organizational structures and distinct operational objectives. For example, a large organization having an aircraft engine business and an industrial systems business may have totally different operations, but the businesses may be able to collaboratively buy common items such as hand tools or small batteries under leadership of the GCL. In general, while the processes are described herein for procuring items, the process may also be performed for procuring services to be performed. A “separate business unit” or “business unit,” as generally used herein, refers to a separate profit and loss center or group within a larger business organization.

The screen 400 does include a initial purchase order date field 402 that allows the author to enter an anticipated date that a first purchase order will be submitted to the winning supplier at the conclusion of the auction. A save and proceed button 404 allows the author to save current field entries and proceed to an auction general information screen 500 as shown in FIG. 5. The screen 500 allows the author to review the fields previously completed. Additionally, the screen 500 includes a GCL Approved field 502 and a Business Approved field 504 which indicate whether the GCL and appropriate business unit approve of conducting the auction. A Length of Contract field 506 indicates how long a contract with a winning supplier will extend.

A GCL field 508 identifies the GCL associated with the commodity identified in the commodity field. The system may link the commodity and GCL fields so that selecting one commodity from the pull-down menu automatically selects an associated GCL for the commodity. A task assignment section 510 allows the author to assign tasks to various individuals within the business organization, such as the auction owner (e.g., author), e-business leader, GCL, e-auctions team, black belt, pole representative and e-auctions analysts. A Business Electronic Sourcing Leader (“BSL”) is delegated by each business unit to migrate sourcing or requisitioning activities into more efficient electronic methods. The BSL's role with respect to electronic auctions is to ensure that business goals are met, such as sufficient percentage of procurement performed through electronic auctions, establishment and accomplishment of savings targets and the like. The BSL may be the buyer.

An “e-auctions” or “e-sourcing team,” as generally used herein, refers to a central functional group whose purpose is to schedule and facilitate electronic commerce for all business units. The group ensures that both buyers and suppliers have appropriate protected access to business tools used to prepare for and conduct electronic auctions. This group maintains a help desk during auction events to assist with any technical problems or other questions that may arise and thereby facilitate the auction. The group ensures training of all users, both buyers and suppliers, in using the process. Furthermore, the group reports overall business metrics for electronic procurement with respect to business objectives or a “business road map.” Further details regarding assigning tasks and notifying individuals under an auction system may be found in U.S. patent application Ser. No. ______, entitled “METHOD AND SYSTEM FOR ASSIGNING AND TRACKING TASKS, SUCH AS UNDER AN ELECTRONIC AUCTION” (Attorney Docket No. 243768039US). A Copy this Auction button 512 allows the author to copy the currently displayed page to create a new auction general information screen. For example, the author may access a previously stored auction screen to use as a basis for creating a new auction screen.

Under the depicted embodiment, certain fields are mandatory. For example, all of the fields of the Create New Auction screen 204 may be mandatory except the estimated total value, savings start value and comments fields 316, 318 and 320, respectively. Likewise, for the general information screen 500 of FIG. 5, all of the fields depicted therein may be mandatory, except the initial purchase order date, length of contract fields 402 and 506, and one or more of the fields in the task assignment section 510.

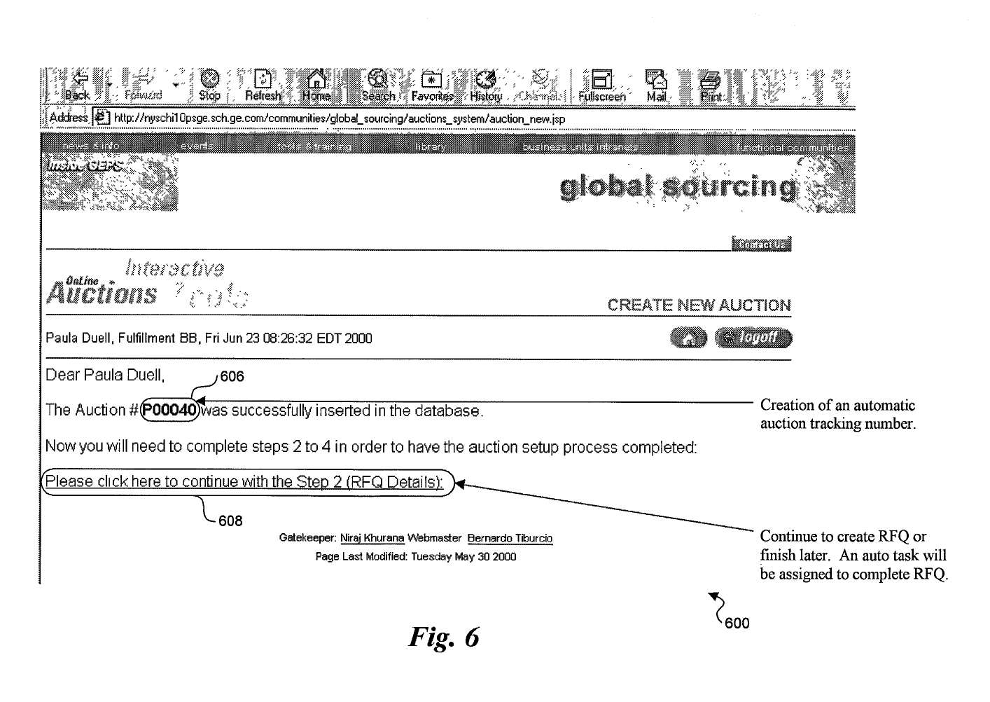

Referring to FIG. 6, once the author has clicked the next button 332 (FIG. 3) or a save button 602 or RFQ Info tab 604 (FIG. 5), an acknowledgment of auction creation screen 600 is displayed to the author. As shown in FIG. 6, the auction is assigned an auction number 606 (e.g., “P00040”). The auction number may be a key field linking all other forms and tools described herein. Using this field will allow the author or other user to pull all field entries for an auction (such as a prior auction), and thereby permit the author to change only entries from the prior auction to create a new auction rather than starting from scratch. Also displayed is a hypertext link 608 to proceed with completing an RFQ details page.

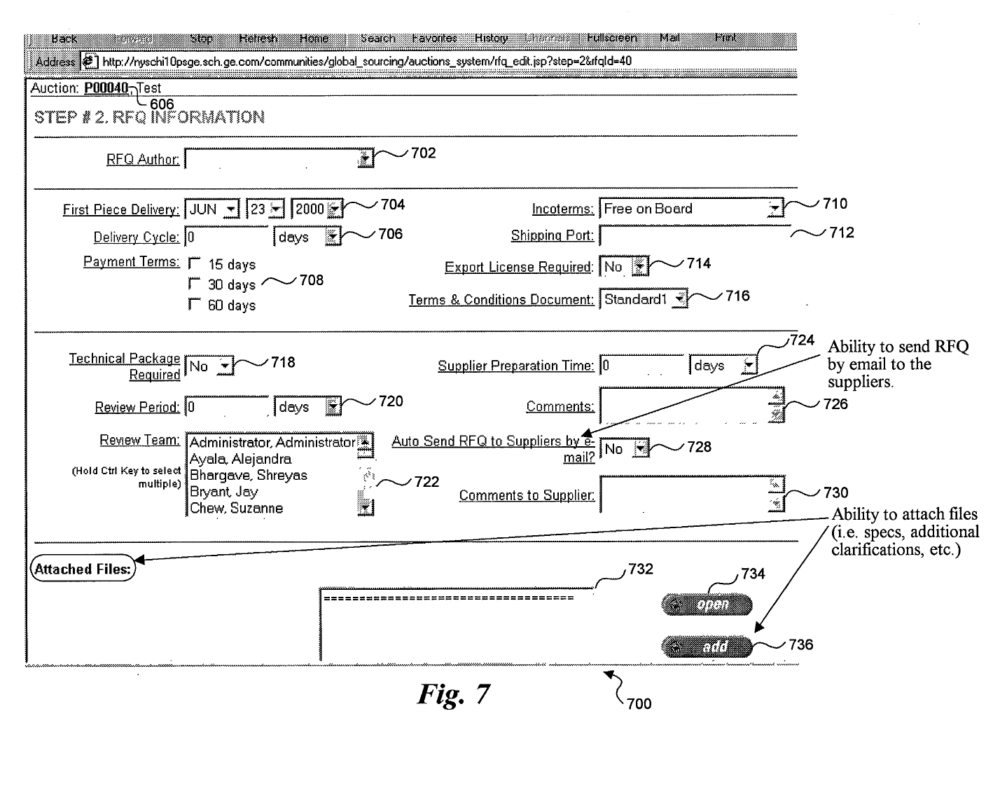

Referring to FIG. 7, an example of a Web page screen for creating an RFQ 700 is shown. The RFQ Web page screen 700 may form a cover sheet that provides important details regarding the RFQ, while the bulk of the RFQ information is provided in attachments and other documents as described herein. An RFQ Author field 702 automatically displays the name of the computer user currently accessing the Web page to author the RFQ. However, the user may select another author to be associated with the RFQ by completing the field or using the pull-down menu (such as in the case of a secretary completing the form for another individual). The field may link to a global address book to automatically enter the current user's name based on the login ID.

A First Piece Delivery field 704 and a Delivery Cycle field 706 permit the author to designate the first delivery date for an item to be purchased under the auction and for delivery cycles thereafter. The field 704 requires the author to indicate when the first production-support delivery resulting from the auction is required, while the field 706 requires the author to indicate the usual or expected delivery cycle for the type of item being procured. The fields 704 and 706 may be used with the business organization's existing MRP system. Alternatively, a Start Delivery Date field and an End Delivery Date field may be provided instead, with the system automatically calculating cycle times therefrom.

A Payment Terms field 708 allows the author to select from one of several depicted payment cycles (between 15 and 60 days). The default may be 60 days. An Incoterms field 710 requires the author to identify the appropriate delivery Incoterm. “Incoterms” refer to International Chamber of Commerce standard business terms. Selecting an Incoterm causes the system to general mandatory fields for either the author of the RFQ or the supplier. A pop-up window may supply explanations for the terms and the mandatory fields that they provide when selected. As a default, Delivered Duty Paid is furnished for this field. The Incoterms may include:

Ex Works (EXW: supplier must enter the name of a place as part of its bid),

Free Alongside Ship (FAS: supplier must enter a name of a shipping port in its bid),

Free Carrier (FCA: the supplier must enter a name of a place as part of its bid),

Free Onboard (FOB: the supplier must enter a shipping port in its bid),

Cost & Freight (CFR: the author must name a port of destination as part of the RFQ),

Cost Insurance & Freight (CFI: the author must name a port of destination in the RFQ),

Carriage & Insurance Paid (CIP: the author must name a place of destination in the RFQ),

Carriage Paid To (CPT: the author must name a place of destination in the RFQ),

Delivered at Frontier (DAF: the buyer must name a place in the RFQ),

Delivered Duty Paid (DDP: the buyer must name a destination in the RFQ),

Delivered Duty Unpaid (DDU: the buyer must name a destination in the RFQ),

Delivered Ex Quay (DEQ: the buyer must name a port of destination in the RFQ), and

Delivered Ex Ship (DES: the buyer must name a port of destination in the RFQ).

A Shipping Port field 712 allows the author to enter a shipping port for the item.

An Export License Required field 714 allows the author to enter whether an 51 export control license is required to export the RFQ (e.g., the RFQ has technical documents attached). A pull-down menu includes choices of “yes,” “no” and “I don't know.” Anything but a “no” entry causes the system to automatically send an inquiry email or other electronic notification to a legal contact to determine whether an export license is required before submitting the RFQ to suppliers or other individuals outside of the United States (or other nation in which the RFQ is generated). A Terms & Conditions field 716 allows the author to identify one of several previously created documents or text files containing current versions of business and commodity-specific legal terms and conditions. The system may provide a list of standard default terms and conditions while also providing terms and conditions documents specific to each business within the organization.

A Technical Package Required field 718 indicates whether a technical review team should perform a technical review before the auction. In other words, the author, under field 718, specifies whether, before the auction, a technical review package must be submitted by a supplier to be evaluated by the technical review team. A Review Period field 720 allows the author to indicate how long the technical review team has to review technical proposals before the auction. A default value may be, for example, two weeks. A Review Team field 722 allows the author to create a review team by identifying one or more individuals provided in a list. The author may select more than one individual from the list, where the names may be taken from a global address book and presented in alphabetical order within the field 722. If the author indicates that a technical review is required (field 716 marked yes), then the Review Period and Review Team fields must be completed.

A Supplier Preparation Time field 724 allows the author to indicate how long after receiving the RFQ a supplier has to prepare technical proposals and bids for the auction. As with the Review Period field, the screen 700 has a digit portion and a pull-down units menu (having days, weeks and months). A default period may be two weeks, and if the author selects a time period of less than two weeks, explanatory comments must be provided in a comments field 726. Otherwise, the author has an option to provide comments within the comments field 726.

An Auto Send RFQ to Suppliers by email field 728 allows the author to determine whether a completed RFQ is automatically sent to suppliers by email (such as after the RFQ is complete and the author clicks a button to email the RFQ to selected suppliers). A default setting is “no,” indicating that the RFQ is, instead, simply posted to a Web site for suppliers to download. If “yes” is selected, then the author may add comments to a field 730 that will form the text of the email message forwarding the RFQ to suppliers.

An Attached Files field 732 provides a listing of files to be attached to the RFQ, such as specifications, additional clarifications, drawings, etc. A macro may be provided to load drawings, specifications and image files to the server supporting the auction Web site. A document library folder may be created specifically for a given auction so that two auctions with file attachments having the same name will not interfere with one another. An open button 734 allows the author to open any attached files listed in the Attached Files field 732, while an add button 736 allows the author to add files to the field (such as by opening a directory of files or allowing the author to search for files on a local network or directory).

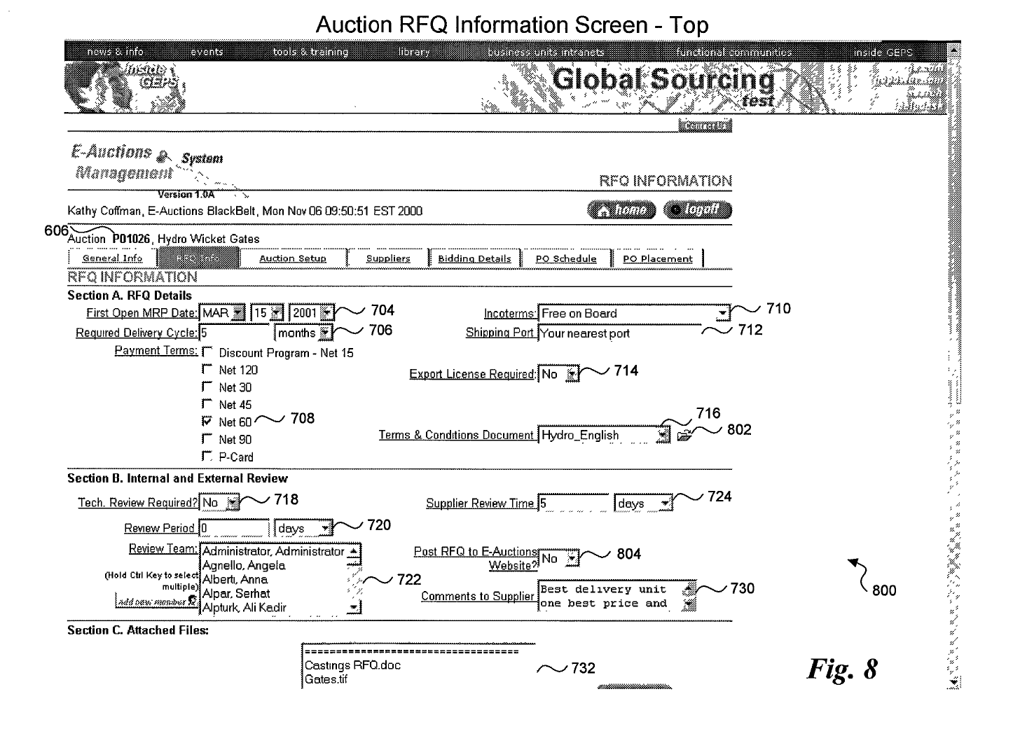

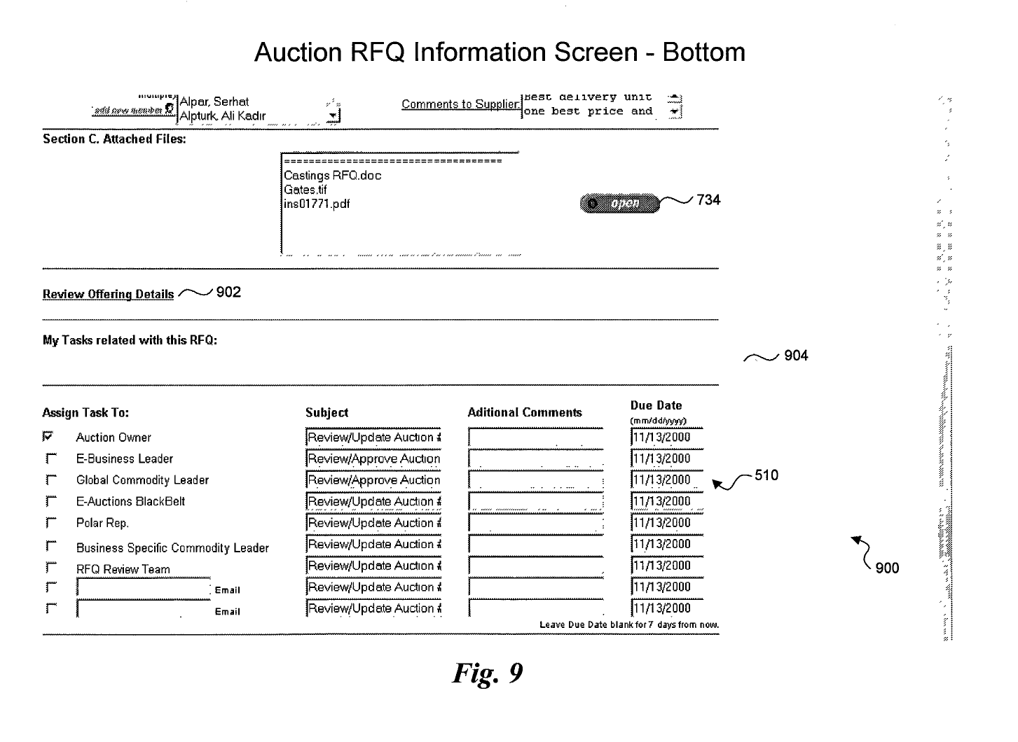

Referring to FIGS. 8 and 9, an example of an alternative Web page screen 800 is shown for creating an electronic RFQ. As shown in FIG. 8, the Payment Terms field 708 includes additional options over those shown in FIG. 7, such as a Discount Program—Net 15, which is a commercial agreement that rewards the purchaser for rapid payment by providing additional discount. Normal payment terms are 60 days after receiving a product/service. A 1.5% discount may be accepted by the supplier for payments issued within 15 days. This assists many suppliers with cash-flow issues associated with large transactions. Additional options also include “P-Card”. A purchasing Card or “P-card” is a corporate credit card (e.g. Mastercard) which is used much like government MPAC cards. Organizations may use the P-Card for purchases under a defined maximum. Suppliers receives immediate payment from the credit card agency and the purchasing business benefits from reduced invoicing and check payment transactions. Under this alternative, a default may be net 60 days. If the default is not accepted, then the RFQ author must determine whether special payment terms are acceptable as part of a bid. The author can select all acceptable payment terms by checking one or more boxes, but at least one box must be checked. Under another alternative the author may provide additional payment terms, such as a percentage payable net 30 days, with a remaining percentage to be paid at another time period, such as determined by a corporate finance contract executed with the supplier.

An open folder icon 802 associated with the Terms & Conditions field 716 allows the author to open and view any of the terms and conditions listed within the pull-down menu of this field. Additionally, under an alternative embodiment, clicking on the open folder 802 allows the author to also identify and include new terms and conditions not listed in the pull-down menu.

A Post RFQ to E-Auctions Web site field 804 allows the author to determine whether the completed RFQ is to be posted to an electronic auctions Web site. A default for this field is “yes,” whereas if “no” is selected, the RFQ must be printed and sent by postal mail, common carrier, facsimile or other means. Alternatively, the RFQ may be emailed to suppliers.

As shown in FIG. 9, a Review Offer and Details link 902 is a hypertext link to a document providing details regarding the electronic auction associated with the RFQ and other high-level details regarding the item being auctioned. This links to a data entry form that requires entry of several mandatory items of information such as type of auction (e.g., reverse), quantity of each item to be purchased, description, starting bid price, auction start date/time, and auction end date/time. Additionally, user-defined additional columns (such as length, material, and diameter as in the preceding example) may be added as user-defined (optional) data entry fields. A tasks section 904 lists a current user's tasks related to the RFQ which have been assigned under the task assignment section 510. In the example of FIG. 9, no tasks have been assigned and thus, none are shown within the section 904.

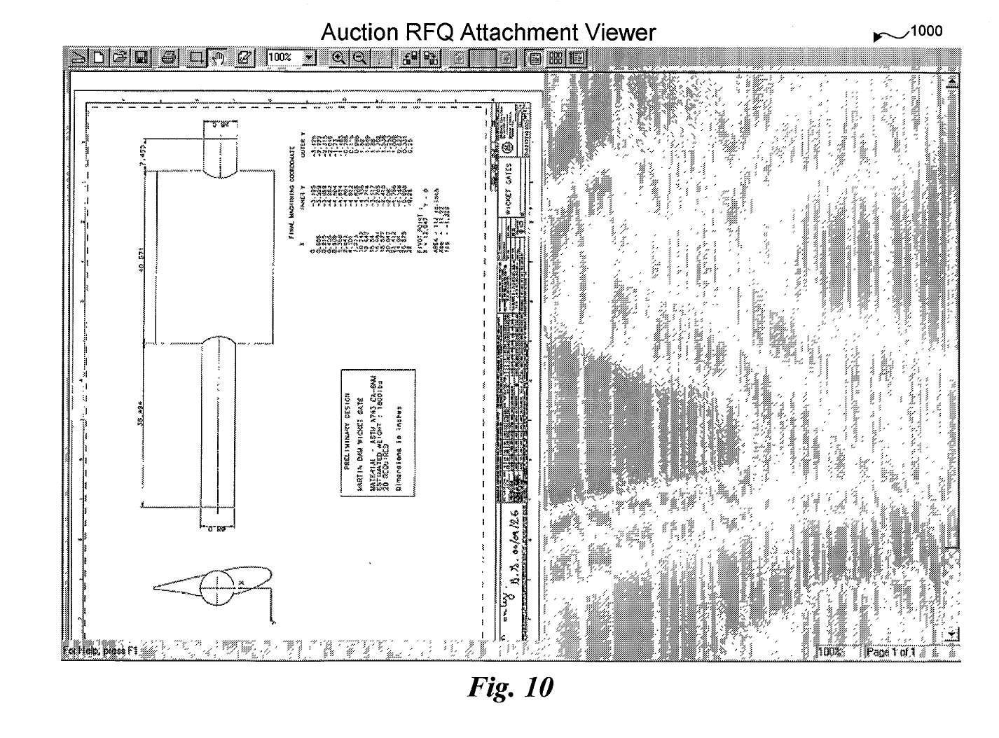

Referring to FIG. 10, an example of an attachment viewer for viewing attachments to an RFQ is shown in a window 1000. Any conventional viewer may be employed for viewing image files, such as .tiff, .vsd, .dwg, and any CAD/CAM file formats, bitmapped (or compressed bitmap) formats, vector-based or matrix-based file formats.

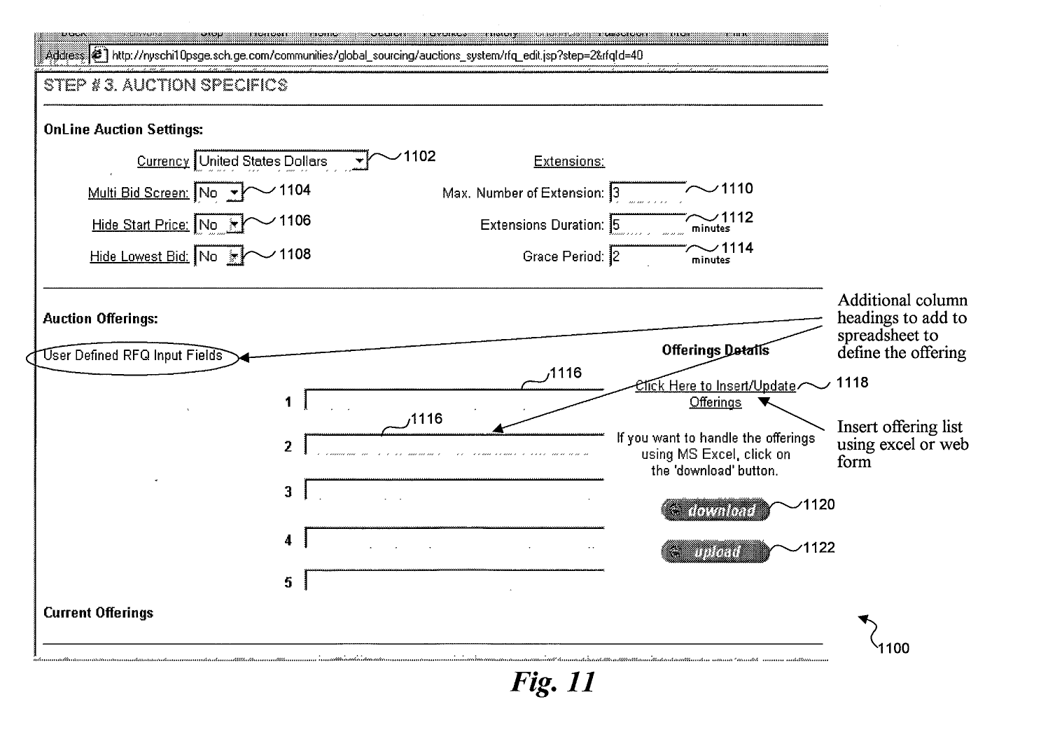

Referring to FIG. 11, if the RFQ is to be used for an auction, the author may be required to provide additional information regarding the auction. An Auction Specifics screen 1100 includes a Currency field 1102 specifying the currency in which bids are to be submitted, with the default being U.S. dollars. A Multi-Bid Screen field 1104 indicates whether the auction will cover more than a single item and necessitate bidding on supplying two or more different items. Prior auctions require suppliers to bid on only one item at a time (one item per screen), requiring a lot of navigating between bid screens, which cost precious time in multiple-item auctions. Under this field, the system enables suppliers to pull up several line items at a time and bid on any/all of them, which speeds up the process of bidding for multiple-item auctions. A Hide Start Price field 1106 allows the author to hide the starting price in any auction. This would give the possible advantage to the business organization of receiving an initial lowest bid that might not be received if the lowest bidding supplier had initially viewed higher bids from other suppliers. A Hide Lowest Bid 1108 allows the author to hide from the suppliers the lowest bid provided under the auction. By hiding the lowest bid, the author ensures that suppliers may not see other bids and may be encouraged to possibly lower a bid they previously submitted. In this case, the supplier will know only whether his lowest bid is the lowest bid.

Fields 1110, 1112 and 1114 allow the author to provide for automatic extensions to the duration of the auction. The author chooses the relevant time-frame (e.g, the last five minutes of auction), the duration of the extension (e.g., five minute extensions), and the number of times the auction can be extended (e.g., three times). In this example, if a bid occurs during the last five minutes of the scheduled duration of the auction, then the auction is extended another five minutes. Such an extension can occur up to a maximum of three times. Thus, a Maximum Number of Extensions field 1110 defines the number of extensions permissible (with a default set at, for example, 3 minutes), an Extensions Duration field 1112 defines in minutes how long each extension period lasts (with the default set at, for example, 5 minutes), and a Grace Period field 1114 defines in minutes how long before (or after) an auction or extension ends additional bids will be accepted (with a default set at, for example, 2 minutes). Once the author enters a value in one of the fields, the other two fields must be completed.

An Auction Offerings section allows the author to define or present RFQ Input Fields 1116 that the supplier must complete for a bid. Clicking on an Insert/Update Offerings link 1118 opens a window (not shown) that lists user-selectable input fields to be added to the Input Fields 1116. An example of such fields may include:

1. Cost (where the supplier must provide a cost or bid)

2. Order-to-Delivery Cycle (where the supplier must identify the expected delivery cycle for the item being auctioned)

3. Exceptions to Technical Specification (where the supplier must identify any exceptions to the technical specification provided under the RFQ with respect to its bid)

4. Country of Origin (where the supplier must specify the country from which the item originates)

5. Other (where the author may provide one or more additional input fields for the supplier to complete with respect to the electronic RFQ)

In addition to fields to be completed by the supplier, the author may define input fields for the RFQ that must be completed by the author or other individuals involved in the RFQ process. Examples of such additional RFQ input fields include the following:

1. Part or Drawing Number (to specify, for example, internally generated part numbers)

2. Description (to identify any internally generated documents describing the item to be auctioned)

3. Starting Bid Price (to identify a starting bid for all suppliers to employ)

4. Contract Type (which may be “Price Only,” “Cost+Percentage” or “Cost+Flat Fee”)

5. Reserve Price (defining a minimum price for an auction, typically in a forward auction, that a bidder must meet or exceed in order to win the auction)

6. User Defined Field for Item (for example, an author may generate an RFQ for drill bits, and then define three fields such as “Overall Length,” “Material” and “Flute Length,” where these user-defined fields are then placed in the item description field as an RFQ matrix (described below) or spreadsheet having the following item description fields: overall length=[data entered from matrix], material=[data entered from matrix], and flute length=[data entered from matrix])

7. User Defined Attached Files (the author may fill in the blank of the ago title of a file type relating to a specific item, such as “drawings,” “specification,” “digital image,” and/or “application” (e.g., Acrobat® Reader)

With respect to the Contract Type user defined field, the “Price Only” choice opens up a dialogue box requesting the author to complete Buy Quantity, Volume-Based Bid or Percentage of Total Buy fields, while the “Cost+(Percentage of Flat Fee)” causes a dialogue box to open for the author to complete Cost+Basis fields. The Buy Quantity field indicates the amount of the item to be purchased, while the Volume-Based Bid and Percentage of Total Buy allows the author to establish tier pricing structures. For example, if the author selects the Volume-Based Bid option, then a dialogue box may open that presents three or more pricing tiers, such as the following:

Volume-Based Bid

For [I to J−1] units, per item bid price=______

For [J to K−1]units, per item bid price=______

For [K or more] units per item bid price=______

where the values I, J and K represent volume quantities input by the author (e.g., I=0, J=1,000, K=10,000) and where the supplier completes the bid price. Similarly, for Percentage of Total Buy, a dialogue box may open for the author to input I and J values, such as the following:

Percentage of Total Buy:

Estimated volume is [author inserts estimated number of items to purchase under contract]=______

For [O to I−1] percentage per item, price=______

For [I to 1−J] percentage per item, price=______

For [J or greater] percentage, per item, price=______

For a Cost+some basis (percentage or flat fee), the buyer fills in an initial percentage or flat fee as the starting bid under a dialogue box, such as the following:

Cost+[percentage] or

Cost+[flat fee amount], with cost reduction shared, [n percent to supplier]

Thus, the buyer may input a starting percentage or flat fee (with cost reduction percentage shared with the supplier) but not both. The supplier will then enter both an estimated cost and a bid for either the percentage or flat fee markup under the auction.

A download button 1120 allows the author to employ a spreadsheet application for completing the RFQ, such as the user defined input fields 1116. By clicking the download button, a data-entry creation matrix macro may be launched that generates a data-entry table for the RFQ author to complete, such as a down-loadable spreadsheet that, once populated, may be uploaded to fill in appropriate fields by clicking an upload button 1122. (Alternatively, the RFQ author can enter data on-line directly into a database associated with the RFQ being generated.) Automatic addition of offerings (rows) occurs when all data fields pertaining to an auction or offering (row) are completed. An enter data macro may be associated with the data entry matrix creation macro which opens up the data-entry table (where data entered is automatically saved as it is entered) previously created for the author to complete. Once all fields have been defined, the data-entry matrix creation macro may generate a table into which the RFQ author can enter the data requested under the enter data macro. Alternatively, the author may simply upload a spreadsheet to complete the matrix. Any spreadsheet application may be employed, such as Excel by Microsoft Corporation of Redmond, Wash.

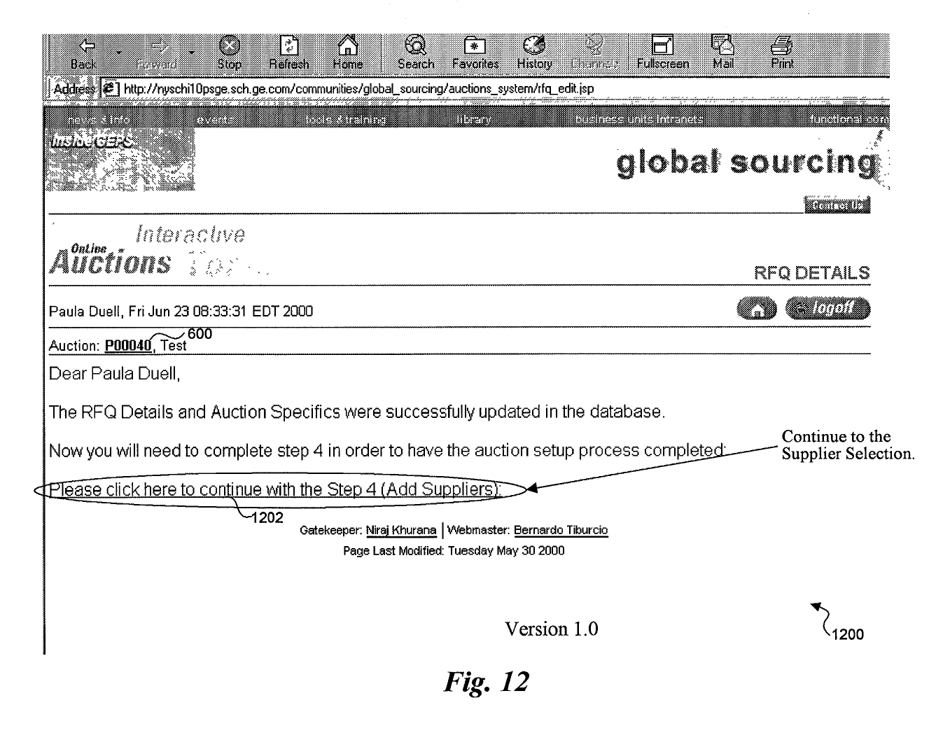

Referring to FIG. 12, an example of a Web page screen 1200 acknowledging RFQ creation is shown. The screen provides instructions to the author to complete the auction setup process and provides a link 1202 that allows the author to proceed to the next step. For example, the next step may require the author or other individuals to identify suppliers to whom the RFQ will transmitted. Further details regarding selecting suppliers may be found in U.S. patent application Ser. No. ______, entitled “METHOD AND SYSTEM FOR ELECTRONICALLY COMMUNICATING WITH SUPPLIERS, SUCH AS UNDER AN ELECTRONIC AUCTION (Attorney Docket No. 243768037US).

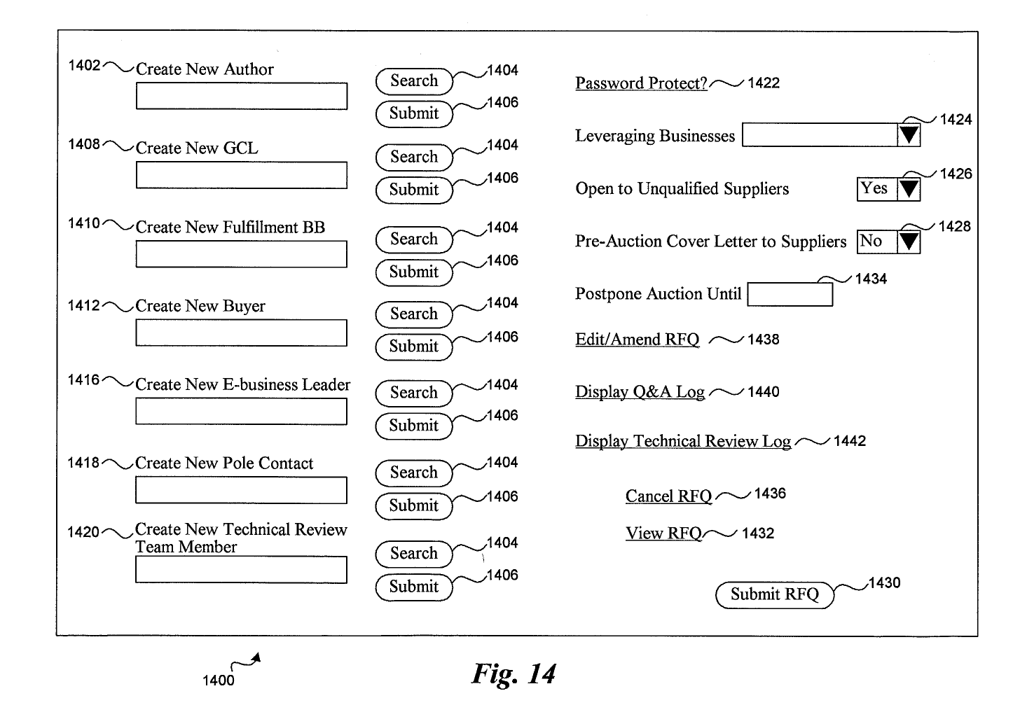

When the link 1202 is clicked on, the system transmits a message containing the RFQ, auction detail information and associated documents to the identified GCL for review and approval. Similarly, the system may submit a message to identified pole personnel (if any) to receive the RFQ, etc. Concurrently therewith, the system provides a Submit Date for the completed RFQ that may be used to determine how long the GCL takes to approve the RFQ, as well as to establish time periods for various other tasks or activities of individuals identified in the RFQ and auction. Rather than employing the link 1202, a separate Submit RFQ button 1430 (shown in FIG. 14) may be provided permits the author to determine when the RFQ is complete and ready to be submitted to the GCL and others.

Whenever an RFQ is first generated (or at least one field in one of the RFQ generation screens is completed), the system may automatically assign an electronic auction number and time stamp the Web page form being completed by the author, such as with a date from a clock running on the server. This RFQ start date may automatically measure when the RFQ is initiated for span measurements. Furthermore, the system may automatically assign an author to the RFQ being created (even if the author is later changed, as noted above). The RFQ start date and author may be fields not typically displayed, but which may be displayed to the author or a system administrator.

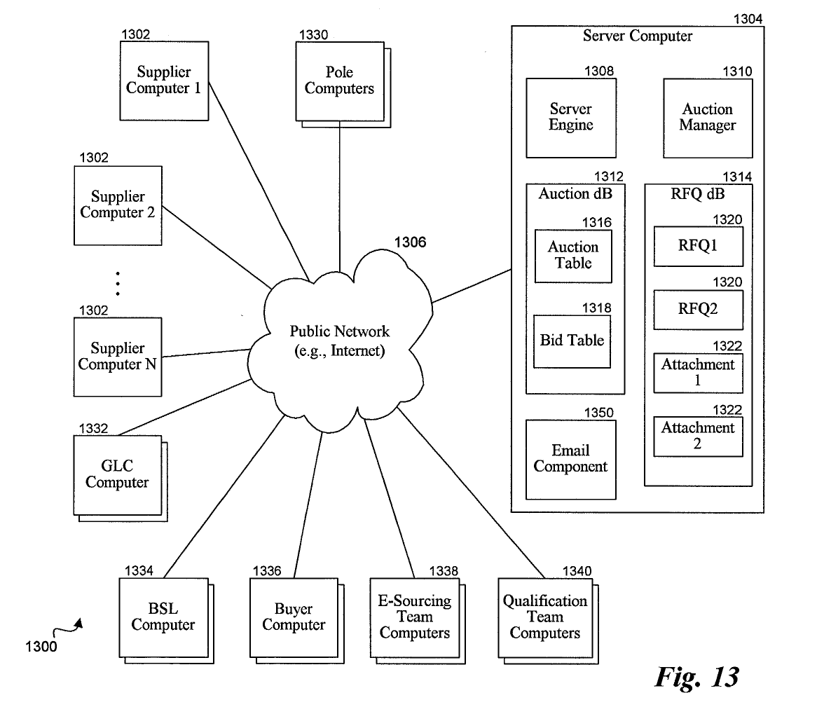

Referring to FIG. 13, a block diagram illustrating an example of components of the electronic auction system described above are shown. One or more client or supplier computers 1302 and a server computer 1304 are interconnected via a public network such as the Internet 1306. The computers may include a central processing unit, memory, input devices (e.g., keyboard and pointing devices), output devices (e.g., display devices and printers) and storage devices (e.g., optical and/or magnetic disk drives), not all shown in FIG. 13, but well known to those skilled in the relevant art. The memory and storage devices are computer-readable media that contain computer instructions implementing the auction system. The supplier computers may use a browser to access the Web pages via the Internet.

The server computer implements the auction system. The server computer system includes a server engine 1308, an auction manager 1310, an auction database 1312 and an RFQ database 1314. The server engine receives requests for resources (e.g., Web pages) via the Internet and coordinates the generation and transmission of the resources. The auction manager coordinates the conducting of the auctions. The auction manager stores auction listings and bidding histories in the auction database. When an auction closes, the auction manager supplies the supplier's submitted bids to the individual conducting the auction and may provide a listing of bids in decreasing order of price. The auction database includes an auction table 1316 and a bid table 1318. The auction table includes an entry for each auction conducted by various buyers within the business organization. The bid table includes an entry for each bid that was placed by a supplier during each auction, with corresponding indicators or links to the appropriate auction in the auction table.

The RFQ database includes one or more electronically generated RFQ's 1320 (two of which are shown in FIG. 13) and associated electronic attachments 1322. While shown in FIG. 13 as stored in the RFQ database of the server computer, attachments (or other documents such as electronic RFQ's) may be stored on another computer. The server computer may, of course, store additional documents, such as electronic qualification plans, electronic white papers and other supplier approval documentation, and other electronic documents or forms described herein.

Documents and most data items involved in supplier approval, qualification, and surveillance may be stored on an electronic Supplier Management System. The electronic RFQ system and the electronic Supplier Management System may be separate systems, or they may be integrated together. Data elements, such as “checked box” fields, may indicate whether a supplier has been pre-approved for receiving RFQ documentation. Under alternative embodiments, supplier access may be more rigidly controlled, such that checking off supplier pre-approval status fields can only be done by certain personnel whose responsibility it is to ensure all required documents for supplier approval (e.g. “white papers”) are accessible in a “Sourcing Quality Library”, in either paper or electronic format.

The server computer is also intercoupled with other computers associated with the business organization, such as one or more pole computers 1330, GCL computers 1332, BSL computers 1334, buyer computers 1336, e-sourcing team computers 1338 and qualification team computers 1340. A “Qualification Team,” as generally used herein, refers to a team comprised of individuals who work for production operations. Depending upon the level of qualification required, the following types of personnel may be involved: manufacturing engineers, buyers, materials and processes engineers, sourcing quality engineers, environmental health and safety engineers, operations leaders, financial analysts, and/or machinists/operators. All of the depicted computers are similar to the supplier computers described above. Additionally, such computers may communicate via electronic mail. Thus, the server computer may include an electronic mail component 1350 to facilitate electronic communication between such computers. While one server computer is generally shown in FIG. 6, more than one server computer may, of course, be employed, such as a server computer for performing auctions (and thus employing the auction manager and auction database), another server computer for providing electronic mail, purchasing, MRP and/or other functions described herein, and a third Web server computer for handling some or all of the various electronic documents and pages described herein. While wired connections are shown, the various computers may be connected via wireless connections. The invention can be embodied in a special purpose computer or data processor specifically programmed, configured or constructed to perform one or more of the computer-executable functions described in detail herein. The invention can be practiced and distributed in computing environments where tasks or modules are performed by remote processing devices, which are linked by a communications network. Aspects of the invention described herein may be stored or distributed on computer-readable media, including magnetic, optically readable and removable computer disks, as well as distributed electronically over the Internet or other networks (including wireless networks). Those skilled in the relevant art will recognize that portions of the invention reside on a server computer, while corresponding portions may reside on other computers. Data structures and transmissions of data particular to aspects of the invention are also encompassed within the scope of the invention. Additionally, the term “computer,” as generally used herein, refers to any data processing device, including portable computers, palm-top computers, personal digital assistants (PDA), Internet appliances, cellular or mobile telephones, wearable computers, set-top boxes, etc.

Various additional screens and alternative embodiments are possible within the system described herein. For example, each screen may include “add” or “info” buttons to be used throughout, alone, or together with a “key” or “legend” button or on a menu bar to permit the author to click thereon for information regarding what information is to be added to a field, or for further details regarding information provided when the info button is clicked. “Create new . . . ” fields may be added throughout the screens to permit the author to add new entries to pull-down menus. Alternatively, as shown in FIG. 14, a separate screen for adding new fields may be provided.

As shown in FIG. 14, an add new screen 1400 includes a Create New Author field 1402 to permit the author of the RFQ or other electronic form to create a record or electronic details for a new author. A Search button 1404 allows the author to search for names in a global address book, such as one stored on an intranet or the server noted above. In one embodiment, by adding a new author to the Create New Author field and clicking a Submit button 1406, the server computer searches the global address book to identify the electronic record associated with the name supplied in the field. From the record, the server then extracts the full name, phone number, email address and other information associated with that person from the stored record. Alternatively, after clicking the Submit button, a new pop-up window opens (not shown) that allows the author to input information with respect to the author to be created, such as phone number, email address and the like.

As shown in FIG. 14, records or fields associated with new individuals involved in the procurement process may also be created, such as a new GCL under a Create New GCL field 1408, a new fulfillment black belt under a Create New Fulfillment BB field 1410, a new buyer (such as an individual within a business unit in the organization or the name of a new business unit) under a Create New Buyer field 1412, a new electronic business leader under a Create New e-business leader field 1416, a new pole contact under a Create New Pole Contact field 1418, and/or a new technical review team member under a Create New Technical Review Team Member field 1420. With each new record created under the fields 1408-1420, a separate pop-up window may be generated by the server computer to permit the author to add additional information regarding the individual, such as full name, phone number, email address, mail stop within the organization, fax number or any other information necessary to create a full record regarding that individual.

Creation or approval of new records may be restricted to database administrators or system administrators, such as creating a new fulfillment black belt, a new e-business leader or a new pole contact. Of course, the system may permit an author to create electronic records associated with other individuals or groups of individuals within the organization, not necessarily only those shown and described with respect to FIG. 14. Each of these individuals may be associated with tasks or other aspects of the RFQ or auction process, as described herein and in the related patent applications described above. By creating records with respect to such individuals, electronic forms and Web pages may be easily completed because such forms may have pull-down menus listing all available choices for a given field where an individual is to be involved or notified. Some fields, however, are automatically completed. For example, a list of pole contacts is automatically created or filled in by the system, not by the author, based on which boxes are checked in the Pole Involvement field 314.

In lieu of the various fields 1402-1420, a single Create New Team Member field (not shown) may be provided which allows the author to identify the type of team member or function of that member from a pull-down menu, such as Buyer, GCL, Sourcing 109. Leader, e-business Leader, black belt, production quality engineer (PQE), sourcing quality engineer (SQE), pole contact, author, quality review member or other individuals involved in the process. Additional fields may be provided to identify the name, phone number, email address or other information regarding the individual for whom a new record is to be created.

The screen 1400 also includes additional features for the author, such as a Password Protect option 1422, that is a link or button to invoke an applet with a pop-up window requesting the author to input a password to be associated with the RFQ document. By password protecting the RFQ document, other individuals may not change the RFQ without the author's permission or knowledge. A Leveraging Businesses field 1424 provides a pull-down menu (alternatively a series of boxes to check) that lists business units within the organization. The author may select one or more choices from the menu that the author identifies as able to participate and possibly gain leveraging opportunity in the auction. Such a field may help the GCL with the auction by providing suggestions to the GCL for cross-business leveraging. In general, any type of user interface for selecting one of several predefined entries may be employed, such as pull-down menus, radio buttons, check boxes and the like. While one type of user interface will be shown or described herein, those skilled in the relevant art will readily recognize that various other user interface techniques may be employed. An Open to Unqualified Suppliers field 1426 allows the author to determine whether unqualified suppliers may participate in the auction, with the default set at “yes.” In general, if unqualified suppliers are permitted to bid in an auction (i.e., the business organization has not reviewed the supplier for full compliance with all of the organization's requirements, such as quality) then either the production timeline permits time to qualify a new supplier or the item does not require particular qualifications, such as shop rags or batteries. If the auction is not open to unqualified suppliers, then it is a “production auction” and all participants are understood to be fully qualified by the business to supply the items/services for which they are bidding

A Pre-auction Cover Letter to Suppliers field 1428 allows the author to determine whether a cover letter is sent to suppliers that provides remarks regarding the auction, with the default set at “no.” If the author chooses the “yes” option, then a dialogue box opens (not shown) that allows the author to find a file, such as a text document, to be used as the letter, or to create a new text document. The system then provides the appropriate link to this letter. The author may then email the letter to suppliers or have the letter posted to the central library on the server for the auction for suppliers to retrieve via the Internet. Alternatively, the field 1428 may provide a large text entry box for the author to simply type a cover letter within the field itself. Such a preauction cover letter or email may be similar to that enabled by fields 728 and 730 described above. Furthermore, the system may provide a date entry field that permits the author to define how many days before the auction the supplier receives such an email. The system provides such an email or cover letter to all suppliers without disclosing the identity of one supplier to another. Under one embodiment, the system provides a standard template, including businesslike letterhead and contact information, thereby providing professional-looking and standardized correspondence and documents being provided to suppliers and other individuals outside the business organization.

A View RFQ link 1432 links to a macro that pops up a window displaying the RFQ document in a format in which the supplier will view the document. The View RFQ link may permit the author to identify fields still needing completion as a final review before submitting the RFQ for approval by GCL and others.

A Postpone Auction Until field 1434 allows the author to enter a number of days, weeks or months that the auction will be postponed, a date to which the auction will be postponed, or “TBD.” If “TBD” is entered and then later changed to a specific date, the system sends a message to the auction administrator, GCL, business e-sourcing leader, auction owner and others involved to verify the new requested auction date. By completing the field 1434, the time period for approval of any previously forwarded RFQ by a GCL or others is likewise postponed, and the appropriate individual is notified that the date for approval or action has been postponed. A Cancel RFQ link 1436 allows the author to send a message to all suppliers, the GCL, the business e-sourcing leader, the buyer, the auction owner and others involved in the auction that the auction has been canceled. Thus, the single link 1436 allows the author to quickly and automatically cancel the auction and notify all relevant parties efficiently.

An Edit/Amend RFQ link 1438 causes an applet to execute and open a pop-up window that requests the author's password to proceed with editing or amending the RFQ. If the author invokes this function after clicking the Submit button, the timer for GCL approval is reset, and GCL approval status is set to “Not Yet Submitted for Approval,” as described herein. The system timestamps each time the author selects to edit or amend the RFQ to help track RFQ generation statistics.

A Display Q&A Log link 1440 allows the author to click on the link to display a window or log of questions and answers posted at the auction Web site. By this method, suppliers having enabled identification numbers and passwords may post questions and see answers from the business at any time between RFQ submission and the auction's end. The Q&A Log (not shown) includes at least four fields, such as the following:

1. question number (a number identifying each question by a unique number)

2. question (text asking the question)

3. response (text answering the question)

4. response author (the name of the individual answering the question)

The Q&A Log may permit cutting and pasting of text from other documents (such as emails). Further, the Q&A Log may include a Submit button to permit anyone to add entries to one or more fields in the log and post such entries to the auction Web site by clicking the Submit button.

Similarly, a Display Technical Review Log link 1442 opens a log of issues arising during technical review of any pre-auction proposals, in a manner similar to the Q&A Log. The technical review log likewise includes the following fields:

1. issue number (identifying each issue with a unique number)

2. issue (text identifying the specific technical issue)

3. disposition (text indicating how the issue has been resolved)

4. disposition author (text indicating who resolved the issue; the system may automatically record the login ID of the author who completed the disposition field)

Under one embodiment, the technical review log is posted to the auction Web site for all suppliers to view (assuming they have access privileges).

As noted above, when the Submit RFQ button is clicked, the RFQ is submitted to the GCL for approval. In general, the GCL may be required to provide approval for any new auctions. Such approval may be provided as a small application (“applet”) or macro on a submitted RFQ which the GCL receives (e.g., as an attachment to an email, an email notifying the GCL of a posted RFQ and containing a link or path name to access the RFQ stored on the server or local network or by other means). By accessing the RFQ, the GCL may be required to initially enter a password. After the GCL reviews the RFQ, a dialogue box requests the GCL to choose one of four (or more) options with respect to the RFQ:

1. Approved As-Is, no leverage opportunity within the business

2. Hold RFQ for Additional Leverage Volume from other business units

3. Approved with Amendments

4. Request Clarifications or Amendments to the RFQ

If the RFQ is approved as-is, the system may send notification to the RFQ author and others involved that the auction may proceed immediately. If the GCL chooses option 2 with respect to the RFQ, then the GCL may be requested by a dialogue box to provide a postponement or hold period (e.g., three months). The system then electronically transmits notification to the RFQ author and others involved in the auction that the auction is to be postponed for the GCL-designated hold period. Also, the system disables the counter that would automatically change the status if the GCL did not review the RFQ within N number of days (as described below). However, the system will initiate a new counter to measure how long the Holding for Additional Leverage Volume status remains. Under option 3 above, the GCL may amend the RFQ. The system may provide an indication to the RFQ author and others of what amendments the GCL made to the RFQ (such as representing RFQ amended text in a different font, color, style, etc.). The system then automatically distributes the RFQ to the RFQ author and other individuals within the organization. Alternatively, after GCL approval is given, the GCL may cause the system to automatically and electronically transmit the RFQ or electronic notification to suppliers, thereby initiating the auction based on GCL approval. When the GCL selects the Request for Clarification or Amendment status, the system automatically opens a new email message addressed to the author in which the GCL may request whatever clarification or amendment the GCL wishes.

The system automatically provides a GCL approval status to each RFQ, which includes the above four options as status values, as well as two additional status values: Not Yet Submitted for Approval and Awaiting GCL Review: N Days to Automatic Approval. Under one embodiment, after the RFQ is submitted for review, an applet begins counting down N number of days from the RFQ Submit date so that the system may track and determine a number of days until the RFQ is automatically approved. If the GCL fails to review or approve the RFQ within N number of days, then the system automatically changes the status of the RFQ to Approved As-is, No Leverage Opportunity.

While not shown, the system may provide an RFQ Type field to permit the author to determine how the RFQ is to be distributed (i.e., manual, email, Web based, etc.). If manual is selected, then the system automatically sends an email to the electronic auction administrator or owner after the GCL approves the auction to let the administrator know to print and mail a copy of the RFQ to all suppliers. If email is selected, the system automatically invokes an electronic distribution tool (e.g., email component 1350) to email a copy of the RFQ to all suppliers. If the Web page option is selected, the system posts the RFQ and all necessary files to a separate library on the Web server (if such files are not already present) and sends an email message to suppliers providing them with a password and location of the files on the Web server. A default is web-based distribution with an e-mail notification to suppliers, which provides lower costs and cycle-time reductions to the business organization.

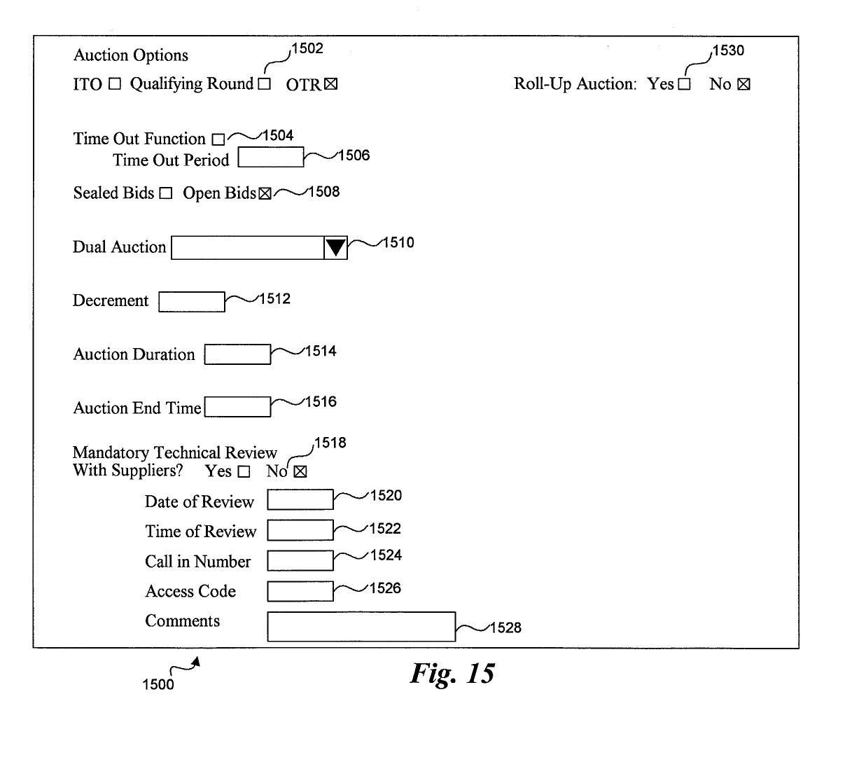

Referring to FIG. 15, an example of a Web page screen 1500 for providing the author with additional options regarding an auction are shown. A field 1502 identifies whether logic is to be set to indicate whether the gross auction volume is to be counted toward business goals (such as a goal of procuring a certain dollar amount of goods via auction) or whether the auction is done merely to obtain pre-quotes to provide more accurate proposals to the business organization's customers. If an ITO (“Interest To Order”) box is checked, the RFQ will state that the auction is for price-checking only. If a Qualifying Round box is checked, the RFQ will state that only those successful bidders in the qualifying round auction will be invited for the OTR auction to follow. An OTR (“Order to Requisition”) box is checked by default. If the author selects either the ITO or Qualifying Round boxes, the gross auction amount will not be added to the gross auction total for business metrics or other business goals. If the ITO or Qualifying Round boxes are checked, the default auction type will be Reverse Sealed.

A Time Out Function box 1504 allows the author to determine whether a time-out restriction for bidders is to be imposed. For example, if a supplier is logged on and has not bid on an item within a time-out period, the logon ID for that supplier will be deactivated for the remainder of the auction. A time-out period 1506 allows the author to record the maximum amount of time that a supplier may be logged on to the Web site without making a bid before the login ID is deactivated. A default value may be, for example, 20 minutes. Alternatively, the time-out period may be omitted because often there is no advantage to timing out a supplier and auctions may be brief in duration.

A bids section 1508 allows the author to determine whether bids are sealed (so that suppliers may not see other bids) or open, as is known in the field of auctions. A Dual Auction field 1510 allows the author to determine whether qualified and unqualified suppliers may bid together or whether qualified and unqualified suppliers bid in different, but concurrent auctions. A Decrement field 1512 may be mandatory for a reverse auction type and may have a number from, for example, 0.001 to 10,000, where the units are currency.

An Auction Duration field 1514 and an Auction End Time field 1516 allow the author to indicate the duration of the auction (with the default set at, for example, 3 hours), and identify the auction end time. Based on the end time, duration and previously identified date for the auction, the system may determine the start date of the auction and other time variables described herein with respect to an auction.

A Mandatory Technical Review section allows the author to determine whether suppliers must participate a mandatory technical review meeting by selecting one of two boxes 1518 (with the “no” box selected as a default). If the “yes” box is selected, the following fields must be completed to permit suppliers to participate in a technical review before the electronic auction date: a Date of Review field 1520, a Time of Review field 1522, a Call in Number field 1524 (for a conference call) and an Access Code field 1526 (to access the conference call). A Comments field 1528 allows the author to provide any comments with respect to the technical review. A default for the date and time of the review is the day of the auction, one hour before the scheduled start of the auction. By completing the fields in the mandatory technical review section, the RFQ is modified to include the information within these fields. If the technical review is mandatory, then only those suppliers that participate in the review will be permitted to participate in the auction. Thus, the author or other individual may associate a denied access flag with one or more suppliers who failed to participate in the technical review. If any of the suppliers attempt to access the auction, they will receive an error message, such as “Denied access for failure to participate in mandatory technical review.”

A Rolled Up Auction field 1530 permits the author to determine whether to accept individual bids on each offering of several items within an auction, or whether to accept only a “total package” bid for all items being offered under the auction. As a default, the “no” option is selected.

Again, many fields in the above-described screens may be mandatory. The First Piece Delivery field 704 and Delivery Cycle field 706 may be optional. Except for fields 1424, 1426 and 1428, the fields of the screen 1400 are optional. Likewise, except for the fields 1502, 1508, 1514 and 1516, the fields of the screen 1500 are optional. Depending upon certain choices by the author, certain additional fields may be mandatory. For example, if the Mandatory Technical Review field 1518 is set at “yes,” then the fields 1520 through 1526 are mandatory (unless conference calling is not employed and a different type of communication is used). If user-defined fields are employed, these fields may then be mandatory.

While certain user interface techniques are shown and described above, various alternatives are possible. For example, while the mandatory technical Date of Review field 1520 is shown as a single box, this field may employ drop-down date fields, such as for the Auction Date field 324. Alternatively, a button or icon may be provided for this field that opens a calendar from which the author may select a desired date. Many other options are available, as one skilled in the relevant art will recognize.

Referring to FIG. 16, an example of a flow diagram illustrating the method of RFQ generation described above is shown as a method 1600. Beginning in block 1602, the system (server computer 1304) provides a new auction information screen to an author, such as the Create New Auction screen 204 of FIG. 3. Alternatively, the system may provide the screens of FIGS. 4 and 5. In block 1602, the system receives new auction information from the author which is input by the author to the Web page screens and stored on the system.

In block 1604, the system provides one or more RFQ information screens, such as the RFQ information screen 700 of FIG. 7. Alternatively, the system may provide the screens 800 shown in FIGS. 8 and 9. In block 1606, the system receives new RFQ information from the author, as well as any necessary attachments for the RFQ, such as drawings, text documents and the like, as described above. In block 1608, the system provides any additional screens to the author, such as the auction specifics screen 1100 of FIG. 11. Alternatively, or additionally, the system may provide the screens 1400 and 1500 of FIGS. 14 and 15. Such additional screens may be automatically provided to the author, or provided to the author upon request based on user input to the system.

After receiving additional input to these screens in block 1610, the system in block 1612 distributes the RFQ, auction and other information for appropriate approval. Distribution to and approval from any individual within the business organization, such as the GCL, may occur. Alternatively, block 1612 may be omitted if no additional approval or review of the RFQ is required. In block 1614, if approval is received, then in block 1616, the system distributes the RFQ to suppliers electronically. Alternatively, the system may print out the RFQ for manual distribution to suppliers. If approval is not received, then in block 1618, the RFQ is revised or held, as noted above, and the method loops back to block 1614. Under the system, the RFQ and other screens may be stored at any time during the method 1600, to be later retrieved and completed by the author. Additionally, the author may create draft RFQs for a variety of items to be procured by the organization, well before the need to procure such items arises. Thus, when the need does arise, such RFQs and auction details have been already provided (and possibly approved) to thereby streamline procurement of such items. Further details regarding an overall procurement system may be found in U.S. patent application Ser. No. ______, entitled “METHOD AND SYSTEM FOR PROVIDING INTERNATIONAL PROCUREMENT, SUCH AS VIA AN ELECTRONIC REVERSE AUCTION” (Attorney Docket No. 243768038US).

The system may provide a search feature (not shown) that permits an RFQ author to search for and identify any RFQs similar to an RFQ the author wishes to create. For example, the RFQ may search by a particular commodity or item to retrieve RFQs associated with that item that may be similar to the item to be procured. The author may then modify such retrieved RFQ to create the desired RFQ for the auction.

The system checks for internal consistencies and conflicts between fields completed by the author. For example, if the author set auction duration and completion times that would cause the auction to overlap with a scheduled time and date for a technical review, the system would provide the author with an error message and request the author to modify either the technical review or auction times. Likewise, while the system automatically inputs certain fields based on links between fields (such as GCL being linked to the commodity), the system will provide error messages to the author when an entered field may conflict with logic in the system for another field to request the author to provide accurate form completion.

One skilled in the art will appreciate that the concepts of the above system can be used in various environments other than the Internet. For example, the concepts can also be used in an electronic mail environment in which electronic mail messages may be used to create RFQs and provide information on auctions. Also, various communication channels may be used instead of the Internet such as a local area network, wide area network, or a point-to-point dial-up connection. The server system may comprise any combination of hardware or software that can support these concepts. In particular, a Web server may actually include multiple computers. A client system may comprise any combination of hardware and software that interacts with the server system. Client systems may include television-based systems, Internet appliances and various other consumer products through which auctions may be conducted, such as wireless computers (palm-based, wearable, mobile phones, etc.). Moreover, the concepts of the present invention may be applied to auctions that are not supported or are only partially supported by computer systems.

Unless the context clearly requires otherwise, throughout the description and the claims the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic commerce systems, not exclusively the RFQ and reverse auction system described above.

The elements and steps of the various embodiments described above can be combined to provide further embodiments. All of the above references, U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all electronic commerce systems that operate under the claims to provide a method for procurement. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I claim:

1. In a public computer network connecting a buyer organization and two or more supplier computers each having a browser, wherein the supplier computers are coupled to a set of one or more server computers associated with the buyer organization over the public computer network, a method comprising:
at at least one server computer in the set of server computers, providing an auction information electronic form, wherein the auction information electronic form includes two or more mandatory data input fields;
at at least one server computer in the set of server computers, receiving information provided to the auction form, including the two or more mandatory data input fields, and creating an electronic request to schedule a new reverse auction based on an identified item to procure;
at at least one server computer in the set of server computers, providing a standard request for quotations (“RFQ”) electronic form, wherein the standard RFQ electronic form includes two or more mandatory data input fields;
at at least one server computer in the set of server computers, receiving information provided to the standard RFQ form, including the two or more mandatory data input fields, and creating an electronic RFQ with respect to the identified item;
at at least one server computer in the set of server computers, electronically distributing the created RFQ for authorization within the buyer organization; and
at at least one server computer in the set of server computers, electronically distributing the created RFQ to the at least two supplier computers over the public computer network after receiving authorization.

2. The method of claim 1 wherein the public computer network is the World Wide Web, wherein the browser is a web browser, wherein the supplier computers access at least one of the server computers over the public computer network via an identification (ID) and password,
wherein the auction and RFQ forms are web page forms stored in a central database coupled to at least one server computer in the set of server computers;
wherein the two or more mandatory data input fields of the auction form include a commodity field, an auction date field, an auction name field and an auction type field;
wherein the two or more mandatory data input fields of the standard RFQ form include a payment terms field, a delivery cycle field, a technical review field and an attachment field, wherein the attachment field identifies at least one document in the database for association with the created RFQ;
wherein at least one server computer in the set of server computers provides a question and answer web page accessible by the supplier computers for posting questions and receiving answers; and
wherein at least one server computer in the set of server computers employs logic to check time spans between a date input to the auction date field and other data input fields in the auction and RFQ forms.

3. A system for facilitating procurement of an item under an auction from one of two or more suppliers, the system comprising:
at least one server computer, wherein the server computer is operable:
to provide a request for quotations (“RFQ”) electronic form, wherein the RFQ electronic form includes at least one mandatory data input field;
to receive information provided to the RFQ form, including the mandatory data input field, and create an electronic RFQ with respect to the item to procure; and
before the auction, to electronically distribute the created RFQ to at least one supplier.

4. The system of claim 3 wherein electronically distributing comprises assisting in conducting an electronic reverse auction between a buyer computer associated with a buyer organization and supplier computers associated with the two or more suppliers, wherein a public computer network couples the buyer and supplier computers and the server computer; and wherein the server computer includes a database coupled thereto and is further operable to:
provide an auction information electronic form, wherein the auction information electronic form includes at least one mandatory data input field;
receive information provided to the auction form, including the mandatory data input field,
create an electronic request to schedule a new reverse auction based on the item to procure; and
electronically distribute, via electronic mail, the created RFQ for authorization within the buyer organization, wherein the RFQ form is an electronic web form having two or more mandatory and standard input fields and at least one optional buyer defined and customizable input field, and wherein the database centrally stores previously completed RFQ and auction forms for previously conducted auctions for retrieval and modification for a new auction.

5. The system of claim 3 wherein the server computer is coupled to a database and the World Wide Web;
wherein the RFQ form is a web page form stored in a central database coupled to the server computer;
wherein the mandatory data input fields of the standard RFQ form include an attachment field, wherein the attachment field identifies at least one document in a central library of the database for association with the created RFQ and a payment terms field, a delivery cycle field or a technical review field;
wherein the server computer provides a question and answer or technical review web page accessible by supplier computers for posting questions and receiving answers; and
wherein at least one server computer in the set of server computers employs logic to check time spans between a date input to the auction date field and other data input fields in the auction and RFQ forms.

6. The system of claim 3 wherein the server computer is further operable to:
provide an auction information electronic form, wherein the auction information electronic form includes at least one mandatory data input field;
receive information provided to the auction form, including the mandatory data input field, and
create an electronic request to schedule a new reverse auction based on the item to procure.

7. The system of claim 3 wherein the RFQ form is an electronic form having two or more mandatory, standard fields, and at least one optional buyer-defined, customizable field.

8. The system of claim 3 wherein the server computer is coupled to a database and wherein the database centrally stores previously completed RFQ forms to be retrieved and modified for a new auction.

9. The system of claim 3 wherein the server computer is further operable to provide an auction information electronic form having at least two mandatory data input fields, wherein the mandatory data input fields of the auction form include an auction date field, and a commodity field, an auction name field or an auction type field.

10. The system of claim 3 wherein the mandatory data input fields of the standard RFQ form include an attachment field, wherein the attachment field identifies at least one electronic document in a central library for association with the created RFQ.

11. The system of claim 3 wherein the mandatory data input fields of the standard RFQ form includes technical review fields, wherein the technical review fields include a first field identifying whether technical review is required, a second field identifying a review period, and a third field identifying either a technical review team or whether a suppliers must participate in a mandatory, pre-auction technical review conference.

12. The system of claim 3 wherein electronically distributing the created RFQ includes sending at least a portion of the RFQ by electronic mail and storing at least one electronic document at a network location, wherein the electronic document may be accessed by a remote computer via a public computer network.

13. The system of claim 3 wherein the server computer includes a database coupled thereto and is further operable to automatically and electronically distribute a pre-auction electronic mail message to two or more supplier computers associated respectively with the two or more suppliers, wherein the electronic mail message does not provide the identity of one supplier to another supplier.

14. The system of claim 3 wherein the server computer is further operable to provide an auction information electronic form having data input fields, wherein the data input fields of the auction form include a time out function field, a dual auction field, or an extension logic field.

15. The system of claim 3 wherein the server computer is further operable to check time spans between a date of the auction and data input fields in the RFQ form.

16. A computer-readable medium whose contents cause a computer system to assist in procuring an item from one of a plurality of suppliers, by:
providing a request for quotations (“RFQ”) electronic form, wherein the RFQ electronic form includes at least one mandatory data input field;
receiving information provided to the RFQ form, including the mandatory data input field, to create an electronic RFQ with respect to the item to procure; and
before the auction, electronically distributing the created RFQ to at least two suppliers.

17. The computer-readable medium of claim 16, further comprising:
providing an auction information electronic form, wherein the auction information electronic form includes at least one mandatory data input field;
receiving information provided to the auction form, including the mandatory data input field, and
creating an electronic request to schedule a new reverse auction based on the item to procure.

18. The computer-readable medium of claim 16 wherein the RFQ form is an electronic form having two or more mandatory, standard fields, and at least one optional buyer-defined, customizable field.

19. The computer-readable medium of claim 16, further comprising providing an auction information electronic form having at least two mandatory data input fields, wherein the mandatory data input fields of the auction form include an auction date field, and a commodity field, an auction name field or an auction type field.

20. The computer-readable medium of claim 16 wherein the mandatory data input fields of the standard RFQ form include an attachment field, wherein the attachment field identifies at least one electronic document in a central library for association with the created RFQ.

21. The computer-readable medium of claim 16 wherein the mandatory data input fields of the standard RFQ form includes technical review fields, wherein the technical review fields include a first field identifying whether technical review is required, a second field identifying a review period, and a third field identifying either a technical review team or whether a suppliers must participate in a mandatory, pre-auction technical review conference.

22. The computer-readable medium of claim 16 wherein electronically distributing the created RFQ includes sending at least a portion of the RFQ by electronic mail and storing at least one electronic document at a network location, wherein the electronic document may be accessed by a remote computer via a public computer network.

23. The computer-readable medium of claim 16 wherein the server computer is further operable to provide an auction information electronic form having data input fields, wherein the data input fields of the auction form include a time-out function field, a dual auction field, or an extension logic field.

24. The computer-readable medium of claim 16 wherein the computer-readable medium is a logical node in a computer network receiving the contents.

25. The computer-readable medium of claim 16 wherein the computer-readable medium is a computer-readable disk.

26. The computer-readable medium of claim 16 wherein the computer-readable medium is a data transmission medium transmitting a generated data signal containing the contents.

27. The computer-readable medium of claim 16 wherein the computer-readable medium is a memory of a computer system.

28. A computer-readable medium containing a data structure having information for display and to assist in procuring an item from one of a plurality of suppliers under an auction, the information comprising:
a first display description defining a request for quotations (“RFQ”) electronic form, wherein the first display description comprises at least two mandatory data input portions corresponding respectively to at least two standard data input fields, and at least one optional data input portion corresponding to a buyer-defined, customizable field,
wherein the at least one optional data input portion corresponds to the item to be procured under the auction, and wherein the at least two standard data input fields comprise at least two fields selected from the set comprising: a payment terms field, a delivery cycle field, a technical review field and an attachment field, wherein the attachment field identifies at least one document for association with the RFQ.

29. The computer-readable medium of claim 28, further comprising:
a second display description defining an auction information electronic form, wherein the second display description comprises at least two mandatory data input portions corresponding respectively to at least two mandatory data input fields, and wherein the mandatory data input fields of the auction form include an auction date field, and a commodity field, an auction name field or an auction type field.

30. The computer-readable medium of claim 28 wherein the data structure includes instructions for the display of the information.

31. The computer-readable medium of claim 28 wherein the data structure represents a Web page.

32. The computer-readable medium of claim 28 wherein the data structure represents a document for display.

33. The computer-readable medium of claim 28 wherein the data structure is a data transmission medium transmitting a generated data signal containing the data structure.

34. A system to assist in procuring items from one of a plurality of suppliers, comprising:
means for providing a request for quotations (“RFQ”) electronic form, wherein the RFQ electronic form includes at least one mandatory data input field;
means for receiving information provided to the RFQ form, including the mandatory data input field, and create an electronic RFQ with respect to the item to procure; and
before the auction, means, coupled to the means for providing and the means for receiving, for electronically distributing the created RFQ to at least two suppliers.

35. The system of claim 34, further comprising:
means for providing an auction information electronic form, wherein the auction information electronic form includes at least one mandatory data input field;
means for receiving information provided to the auction form, including the mandatory data input field, and
means for creating an electronic request to schedule a new reverse auction based on the item to procure.
